(19) United States
(12) Patent Application Publication
(10) Pub. No.: US 2021/0357177 A1
(43) Pub. Date: Nov. 18, 2021

(54) VEHICLE CONTROL DEVICE AND VEHICLE CONTROL METHOD

(71) Applicant: LG Electronics Inc., Seoul (KR)

(72) Inventors: Heejeong HEO, Seoul (KR); Doyun PARK, Seoul (KR); Dongkyu LEE, Seoul (KR); Jaehoon CHO, Seoul (KR)

(21) Appl. No.: 16/487,049

(22) PCT Filed: Nov. 30, 2018
(86) PCT No.: PCT/KR2018/015149

§ 371 Date: Aug. 19, 2019

(51) Int. Cl. G06F 3/16; G10L 15/22; G10L 15/26; G10L 15/08; G06F 16/432; B60W 40/08; B60K 35/00

(52) U.S. Cl. CPC G06F 3/167; G10L 15/22; G10L 15/26; G10L 15/08; G06F 16/433; B60K 2370/165; B60K 35/00; G10L 2015/088; B60W 2040/089; B60W 2540/21; B60K 2370/148; B60W 40/08

(57) ABSTRACT

Disclosed herein is a control method for controlling a vehicle using an agent module generating a dialogue which constructs a dialogue-type response to a received speaking of an occupant. The control method includes: a receiving the speaking of the occupant through a voice input unit; updating the dialogue as a procedure of providing a search result in response to a search request through the speaking of the occupant is performed multiple times; and displaying in real time, on a display, a procedure of updating the dialogue, wherein the updating of the dialogue comprises: updating keywords, inferred from the speaking of the occupant, on the basis of a subsequently input speaking of the occupant; and providing the search result on the basis of the updated keywords, and wherein, in the displaying on the display, the keywords inferred from the speaking of the occupant through the agent module are displayed with different display attributes and thereby visually distinguishable from each other.

### TECHNICAL FIELD

The present invention relates to a vehicle control device and a vehicle control method.

### BACKGROUND ART

Vehicles may be classified as internal combustion engine vehicles, external combustion engine vehicles, gas turbine vehicles, electric vehicles, and the like, according to types of prime movers used therein.

Recently, for the safety and convenience of drivers and pedestrians, smart vehicles have been actively developed and research into sensors to be mounted on the intelligent vehicles have actively been conducted. Cameras, infrared sensors, radars, global positioning systems (GPS), lidars, and gyroscopes are used in intelligent vehicles, among which cameras serve to substitute for human eyes.

Due to development of various sensors and electronic equipment, vehicles equipped with a driving assistance function of assisting an occupant in driving and improving driving safety and convenience has come to prominence.

### DISCLOSURE

### Technical Problem

An embodiment of the present invention provides a control device for assisting driving of a vehicle.

Another embodiment of the present invention provides a control device enabling conversation with an occupant during traveling.

Yet another embodiment of the present invention provides a control device capable of providing information desired by an occupant in response to a speaking of the occupant during traveling.

Yet another embodiment of the present invention provides a control device capable of inferring a related keyword in response to a speaking of an occupant during traveling and providing a search result on the basis of the related keyword.

Yet another embodiment of the present invention provides a control device capable of updating a related keyword in response to a speaking of occupant and providing a search result on the basis of the related keyword.

Yet another embodiment of the present invention provides a control method for driving assistance of a vehicle.

Yet another embodiment of the present invention provides a control method for enabling conversation with an occupant during traveling.

Yet another embodiment of the present invention provides a control method for providing information desired by an occupant in response to a speaking of the occupant during traveling.

Yet another embodiment of the present invention provides a control method for inferring a related keyword in response to a speaking of an occupant during traveling and providing a search result on the basis of the related keyword.

Yet another embodiment of the present invention provides a control method for updating a related keyword in response to a speaking of occupant and providing a search result on the basis of the related keyword.

### Technical Solution

A control method according to an embodiment of the present invention for the purpose of achieving the aforementioned objects is a control method for controlling a vehicle using an agent module generating a dialogue which constructs a dialogue-type response to a received speaking of an occupant, the method including: a receiving the speaking of the occupant through a voice input unit; updating the dialogue as a procedure of providing a search result in response to a search request through the speaking of the occupant is performed multiple times; and displaying in real time, on a display, a procedure of updating the dialogue, wherein the updating of the dialogue comprises: updating keywords, inferred from the speaking of the occupant, on the basis of a subsequently input speaking of the occupant; and providing the search result on the basis of the updated keywords, and wherein, in the displaying on the display, the keywords inferred from the speaking of the occupant through the agent module are displayed with different display attributes and thereby visually distinguishable from each other.

The updating of the dialogue may further include: extracting at least one keyword directly included in a first speaking of the occupant as a first search query; extracting at least one keyword inferred from the speaking of the occupant as a second search query; and displaying the first search query, the second search query, and a first search result found on the basis of the first search query.

The control method may further include: after the first search result is provided, receiving a second speaking of the occupant; and when it is determined based on the second speaking that it is necessary to modify at least one keyword in the second into a keyword included in the second speaking, modifying the at least one keyword in the second query into the first search query.

The control method may further include: when it is determined based on the second speaking that it is necessary to re-infer at least one keyword in the second search query, re-inferring the at least one keyword in the second search query and converting the re-inferred at least one keyword into a third search query; and displaying, on the display, a second search result found on the basis of the updated first search query.

In the displaying on the display, the first search query, the second search query, and the third search query may be displayed with different display attributes and thereby visually distinguishable from each other.

In the displaying on the display, the first search query, the second search query, and the third search query may be displayed in different colors.

In the displaying on the display, the first search query, the second search query, and the third search query may be displayed by updating display attributes thereof in real time according to the first speaking and the second speaking which are sequentially received.

The control method may further include displaying the dialogue on the display, wherein a dialogue window for displaying conversation between the occupant and the agent module, and the search result are displayed together.

The search result may provide a list comprising at least one image or at least one text corresponding to the search result.

The control method further comprises: recognizing the speaking of the occupant and converting the speaking into a first text; through the agent module, generating a response to the speaking of the occupant or a second text explaining the search result; and, through a voice output unit, outputting at least a part of the second text, wherein the dialogue window is divided into a first area for selectively displaying the first text and the second text and a second area for displaying the first search query and the second search query, the second area which excludes the first area.

The first text displayed in the first area may include an entire of the speaking of the occupant, and at least a part of the second text may be displayed in the first area as a text, an image, or a graphic object.

The first area may be a circular graphic object.

The first search query and the second search query may be represented by bubble-shaped graphic objects, keywords of a search query may be displayed within independent bubbles, and when the respective keywords may be extracted by an identical criteria or similar criterion, at least a part of a bubble of each of the respective keywords is connected to each other.

A criteria for extracting the keywords may include at least one of a route, location information, time, speaking content of the occupant, or a search source.

At least one keyword forming the second search query may include a keyword extracted by the agent module or received from an external server through a wireless communication unit.

A control device according to an embodiment for the purpose of achieving the aforementioned objects includes: a display; a voice input unit receiving a speaking of an occupant; an agent module generating a dialogue with a dialogue-type response to the received speaking of the occupant; and a controller, wherein the dialogue is constructed of a search request through the speaking of the occupant and a search result provided by the agent module, and the controller displays, on the display, a procedure of updating the dialogue, as a procedure of speaking by the occupant and providing a search result by the agent modules is performed multiple times, wherein the agent module updates keywords, inferred from the speaking of the occupant, on the basis of a subsequently input speaking of the occupant, and provides a search result on the basis of the updated keywords, and wherein the controller displays the keywords, inferred from the speaking of the occupant through the agent module, with different display attributes and thereby visually distinguishable from each other.

The agent module may extract at least one keyword directly included in a first speaking of the occupant as a first search query and extract at least one keyword inferred from the speaking of the occupant as a second search query, and the controller may display, on the display, the first search query, the second search query, and a first search result found on the basis of the first search query.

The agent module may recognize a second speaking of the occupant after the provision of the first search result, and, when it is determined based on the second speaking that it is necessary to modify at least one keyword in the second search query into a keyword included in the second speaking, the agent module may modify the at least one keyword in the second search query to thereby convert into the first search query.

When it is determined based on the second speaking it is necessary to re-infer at least one keyword in the second search query, the agent module may re-infer the at least one keyword in the second search query and extract the re-inferred at least one keyword as a third search query, and the controller may display, on the display, a second search result found on the basis of the updated first search query.

The controller may perform a control operation such that the first search query, the second search query, and the first search result found on the basis of the first search query are displayed with different display attributes and thereby visually distinguishable from each other.

### Advantageous Effects

The control device according to the present invention have effects as follows.

According to at least one of the embodiments of the present invention, a control device for driving assistance of a vehicle may be provided.

According to at least one of the embodiments of the present invention, a control device enabling conversation with an occupant during traveling may be provided.

According to at least one of the embodiments of the present invention, a control device capable of providing information desired by an occupant in response to a speaking of the occupant during traveling may be provided.

According to at least one of the embodiments of the present invention, a control device capable of inferring a related keyword in response to a speaking of an occupant during traveling and providing a search result on the basis of the related keyword may be provided.

According to at least one of the embodiments of the present invention, a control device capable of updating a related keyword in response to a speaking of occupant and providing a search result on the basis of the related keyword may be provided.

The control method according to the present invention have effects as follows.

According to at least one of the embodiments of the present invention, a control method for driving assistance of a vehicle may be provided.

According to at least one of the embodiments of the present invention, a control method for enabling conversation with an occupant during traveling may be provided.

According to at least one of the embodiments of the present invention, a control method for providing information desired by an occupant in response to a speaking of the occupant during traveling may be provided.

According to at least one of the embodiments of the present invention, a control method for inferring a related keyword in response to a speaking of an occupant during traveling and providing a search result on the basis of the related keyword may be provided.

According to at least one of the embodiments of the present invention, a control method for updating a related keyword in response to a speaking of occupant and providing a search result on the basis of the related keyword may be provided.

### DESCRIPTION OF DRAWINGS

FIG. 1 shows an exterior appearance of a vehicle including a control device according to an embodiment of the present invention.

FIG. 2 is an example of an internal block diagram of a vehicle/

FIG. 3 shows a block diagram of a control device according to an embodiment of the present invention.

FIG. 4 shows a plan view of a vehicle including a control device according to an embodiment of the present invention.

FIG. 5 shows an example of a camera according to an embodiment of the present invention.

FIGS. 6 and 7 are diagrams for explaining an example of a method for generating image information based on an image photographed by a camera according to an embodiment of the present invention.

FIGS. 8 and 9 are diagrams showing an interior of a vehicle including a vehicle driving assistance device according to an embodiment of the present invention.

FIGS. 10 to 23 are diagrams showing embodiments of a control device according to embodiments of the present invention.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle as described in this specification may include a car and a motorcycle. Hereinafter, a car will be as an example of a vehicle.

A vehicle as described in this specification may include all of an internal combustion engine vehicle including an engine as a power source, a hybrid vehicle including both an engine and an electric motor as a power source, and an electric vehicle including an electric motor as a power source.

In some implementations, the left of a vehicle means the left of the vehicle in the direction of travel and the right of the vehicle means the right of the vehicle in the direction of travel.

In some implementations, a left hand drive (LHD) vehicle will be assumed unless otherwise stated.

Hereinafter, a user, a driver, an occupant, and a fellow occupant may be mixed according to an embodiment.

In the following description, a control device 100, a separate device provided in a vehicle, executes a vehicle driving assistance function, while exchanging necessary information with the vehicle through data communication. However, an aggregation of some of the units of the vehicle may also be defined as the control device 100. The control device 100 may also be referred to as a vehicle control device 100, a vehicle driving assistance device 100, or a driving assistance device 100.

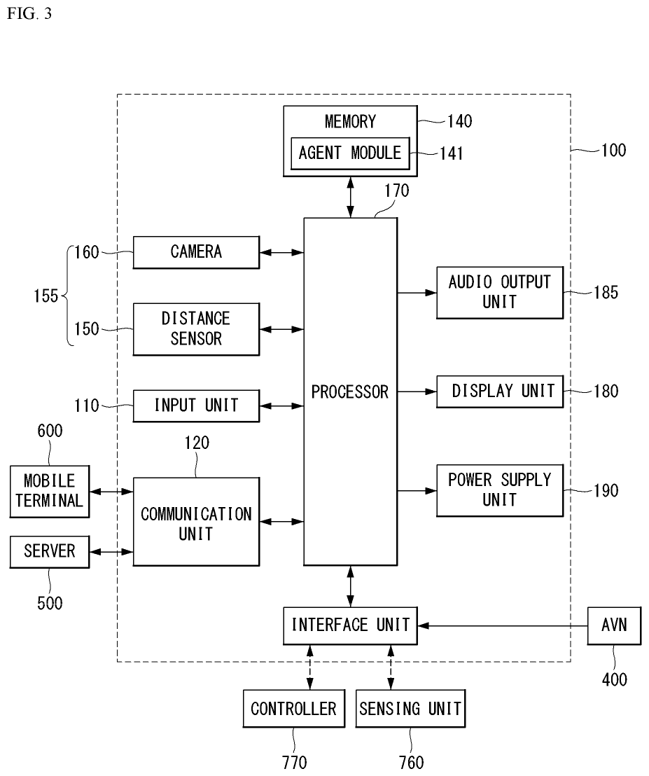

When the control device 100 is a separate device, at least some of the respective units of the control device 100 (see FIG. 3) may not be included in the control device 100 but may be units of a different device embedded in the vehicle. The external units may be interpreted as being included in the control device 100 by transmitting and receiving data through an interface unit of the control device 100.

For the purposes of description, the control device 100 according to an embodiment will be described as directly including the units shown in FIG. 3.

Hereinafter, the control device 100 according to an embodiment will be described in detail with reference to the drawings.

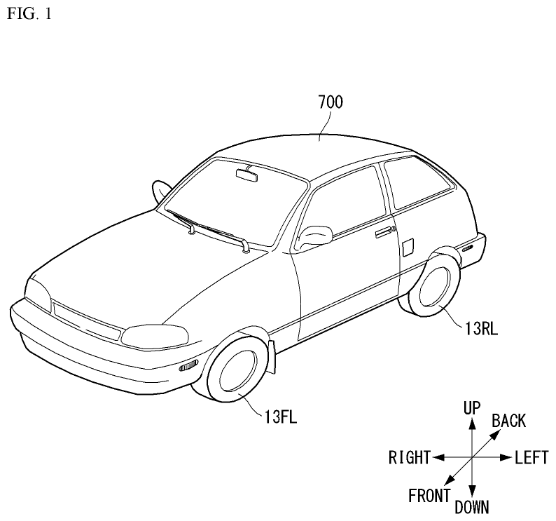

Referring to FIG. 1, a vehicle according to an embodiment may include wheels 13FL and 13RL rotated by a power source and the control device 100 providing driving assistance information to a user.

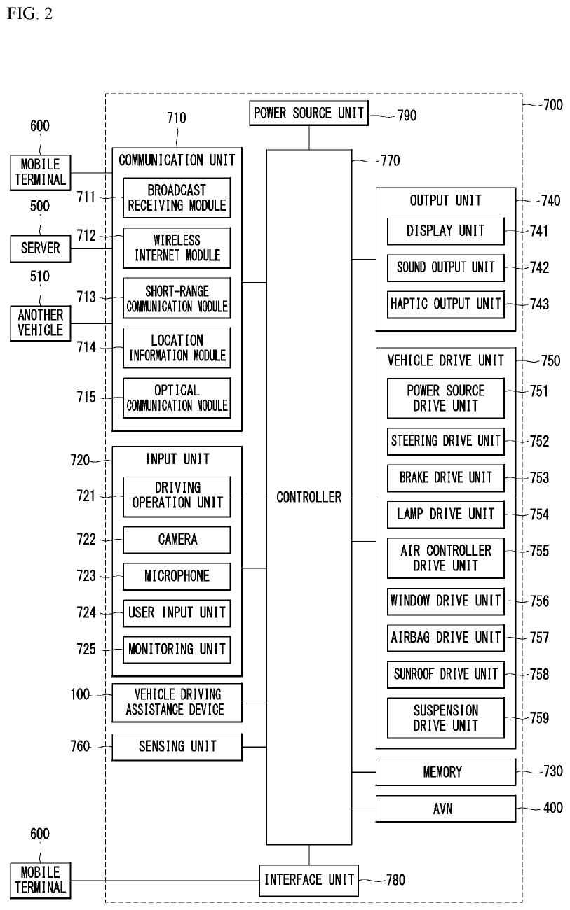

Referring to FIG. 2, the vehicle may include a communication unit 710, an input unit 720, a sensing unit 760, an output unit 740, a vehicle drive unit 750, a memory 730, an interface unit 780, a controller 770, a power source unit 790, the driver assistance apparatus 100, and an AVN apparatus 400. The communication unit 710 may include one or more modules to enable the wireless communication between a vehicle 700 and a mobile terminal 600, between the vehicle 700 and an external server 510, or between the vehicle 700 and another vehicle. In addition, the communication unit 710 may include one or more modules to connect the vehicle 700 to one or more networks.

The communication unit 710 may include a broadcast receiving module 711, a wireless Internet module 712, a short-range communication module 713, a location information module 714, and an optical communication module 715.

The broadcast receiving module 711 is configured to receive a broadcast signal or broadcast associated information from an external broadcast managing server via a broadcast channel. Here, broadcast includes radio broadcast or TV broadcast.

The wireless Internet module 712 is a module for wireless Internet access. The wireless Internet module 712 may be internally or externally coupled to the vehicle 700. The wireless Internet module 712 may transmit or receive wireless signals via communication networks according to wireless Internet technologies.

Examples of such wireless Internet technologies include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), and LTE-A (Long Term Evolution-Advanced). The wireless Internet module 712 may transmit and receive data according to one or more of such wireless Internet technologies, and other Internet technologies as well. For example, the wireless Internet module 712 may exchange data with the external server 510 in a wireless manner. The wireless Internet module 712 may receive weather information and road traffic state information (e.g., Transport Protocol Expert Group (TPEG) information) from the external server 510.

The short-range communication module 713 may assist short-range communication using at least one selected from among Bluetooth™, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication module 713 forms wireless area networks to perform the short-range communication between the vehicle 700 and at least one external device. For example, the short-range communication module 713 may exchange data with the mobile terminal 600 in a wireless manner. The short-range communication module 713 may receive weather information and road traffic state information (e.g., Transport Protocol Expert Group (TPEG) information) from the mobile terminal 600. When the user gets into the vehicle 700, the mobile terminal 600 of the user and the vehicle 700 may pair with each other automatically or as the user executes a pairing application.

The location information module 714 is a module to acquire a location of the vehicle 700. A representative example of the location information module 714 includes a Global Position System (GPS) module. For example, when the vehicle utilizes a GPS module, a location of the vehicle may be acquired using signals transmitted from GPS satellites.

The optical communication module 715 may include a light emitting unit and a light receiving unit.

The light receiving unit may convert light into electrical signals to receive information. The light receiving unit may include Photo Diodes (PDPs) to receive light. The photo diodes may convert light into electrical signals. For example, the light receiving unit may receive information regarding a preceding vehicle via light emitted from a light source included in the preceding vehicle.

The light emitting unit may include at least one light emitting element to convert electrical signals into light. Here, the light emitting element may be a Light Emitting Diode (LED). The light emitting unit converts electrical signals into light to thereby emit the light. For example, the light emitting unit may externally emit light via flickering of the light emitting element corresponding to a prescribed frequency. In some embodiments, the light emitting unit may include an array of a plurality of light emitting elements. In some embodiments, the light emitting unit may be integrated with a lamp provided in the vehicle 700. For example, the light emitting unit may be at least one selected from among a headlight, a taillight, a brake light, a turn signal light, and a sidelight. For example, the optical communication module 715 may exchange data with another vehicle 520 via optical communication.

The input unit 720 may include a driving operation unit 721, the camera 722, a microphone 723, and the user input unit 724.

The driving operation unit 721 is configured to receive user input for the driving of the vehicle 700. The driving operation unit 721 may include the steering input unit 721a, a shift input unit 721b, an acceleration input unit 721c, and a brake input unit 721d.

The steering input unit 721a is configured to receive user input with regard to the direction of travel of the vehicle 700. The steering input unit 721a may take the form of the steering wheel 12 as illustrated in FIG. 1. In some embodiments, the steering input unit 721a may be configured as a touchscreen, a touch pad, or a button.

The shift input unit 721b is configured to receive input for selecting one of Park (P), Drive (D), Neutral (N) and Reverse (R) gears of the vehicle 700 from the user. The shift input unit 721b may have a lever form. In some embodiments, the shift input unit 721b may be configured as a touchscreen, a touch pad, or a button.

The acceleration input unit 721c is configured to receive user input for the acceleration of the vehicle 700. The brake input unit 721d is configured to receive user input for the speed reduction of the vehicle 700. Each of the acceleration input unit 721c and the brake input unit 721d may have a pedal form. In some embodiments, the acceleration input unit 721c or the brake input unit 721d may be configured as a touchscreen, a touch pad, or a button.

The camera 722 may include an image sensor and an image processing module. The camera 722 may process a still image or a moving image acquired by the image sensor (e.g., a CMOS or a CCD). The image processing module may extract required information by processing a still image or a moving image acquired via the image sensor and, then, may transmit the extracted information to the controller 770. Meanwhile, the vehicle 700 may include the camera 722 to capture a forward image or a surround-view image of the vehicle and an monitoring unit 725 to capture an image of the inside of the vehicle.

The monitoring unit 725 may capture an image of an occupant. The monitoring unit 725 may capture an image of biometrics of the occupant.

Meanwhile, although FIG. 2 illustrates the camera 722 as being included in the input unit 720, the camera 722 may be described as being a component of the driver assistance apparatus 100 as described above with reference to FIGS. 2 to 6.

The microphone 723 may process external sound signals into electrical data. The processed data may be utilized in various ways according to a function that the vehicle 700 is performing. The microphone 723 may convert a user voice command into electrical data. The converted electrical data may be transmitted to the controller 770.

Meanwhile, in some embodiments, the camera 722 or the microphone 723 may be components of the sensing unit 760, other than components of the input unit 720.

The user input unit 724 is configured to receive information from the user. When information is input via the user input unit 724, the controller 770 may control the operation of the vehicle 700 to correspond to the input information. The user input unit 724 may include a touch input unit or a mechanical input unit. In some embodiments, the user input unit 724 may be located in a region of the steering wheel. In this case, the driver may operate the user input unit 724 with the fingers while gripping the steering wheel.

The sensing unit 760 is configured to detect signals associated with, for example, the traveling of the vehicle 700. To this end, the sensing unit 760 may include a collision sensor, a steering sensor, a speed sensor, gradient sensor, a weight sensor, a heading sensor, a yaw sensor, a gyro sensor, a position module, a vehicle forward/backward movement sensor, a battery sensor, a fuel sensor, a tire sensor, a steering sensor on the basis of the rotation of a steering wheel, a vehicle inside temperature sensor, a vehicle inside humidity sensor, an ultrasonic sensor, an infrared sensor, a radar, and Lidar.

As such, the sensing unit 760 may acquire sensing signals with regard to, for example, vehicle collision information, vehicle traveling direction information, vehicle location information (GPS information), vehicle angle information, vehicle speed information, vehicle acceleration information, vehicle tilt information, vehicle forward/backward movement information, battery information, fuel information, tire information, vehicle lamp information, vehicle inside temperature information, vehicle inside humidity information, and steering wheel rotation angle information.

Meanwhile, the sensing unit 760 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The sensing unit 760 may include a biometric information sensing unit. The biometric information sensing unit is configured to detect and acquire biometric information of the occupant. The biometric information may include fingerprint information, iris-scan information, retina-scan information, hand geometry information, facial recognition information, and voice recognition information. The biometric information sensing unit may include a sensor to detect biometric information of the occupant. Here, the monitoring unit 725 and the microphone 723 may operate as sensors. The biometric information sensing unit may acquire hand geometry information and facial recognition information via the monitoring unit 725.

The output unit 740 is configured to output information processed in the controller 770. The output unit 740 may include the display unit 741, a sound output unit 742, and a haptic output unit 743.

The display unit 741 may display information processed in the controller 770. For example, the display unit 741 may display vehicle associated information. Here, the vehicle associated information may include vehicle control information for the direct control of the vehicle or driver assistance information to guide vehicle driving. In addition, the vehicle associated information may include vehicle state information that notifies a current state of the vehicle or vehicle traveling information regarding the traveling of the vehicle.

The display unit 741 may include at least one selected from among a Liquid Crystal Display (LCD), a Thin Film Transistor LCD (TFT LCD), an Organic Light Emitting Diode (OLED), a flexible display, a 3D display, and an e-ink display.

The display unit 741 may configure an inter-layer structure with a touch sensor, or may be integrally formed with the touch sensor to implement a touchscreen. The touchscreen may function as the user input unit 724 which provides an input interface between the vehicle 700 and the user and also function to provide an output interface between the vehicle 700 and the user. In this case, the display unit 741 may include a touch sensor which senses a touch to the display unit 741 so as to receive a control command in a touch manner.

When a touch is input to the display unit 741 as described above, the touch sensor may detect the touch and the controller 770 may generate a control command corresponding to the touch. Content input in a touch manner may be characters or numbers, or may be, for example, instructions in various modes or menu items that may be designated.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like. Hereinafter, a touch or a touch input may generally refer to various types of touches mentioned above.

Meanwhile, the display unit 741 may include a cluster to allow the driver to check vehicle state information or vehicle traveling information while driving the vehicle. The cluster may be located on a dashboard. In this case, the driver may check information displayed on the cluster while looking forward.

Meanwhile, in some embodiments, the display unit 741 may be implemented as a Head Up display (HUD). When the display unit 741 is implemented as a HUD, information may be output via a transparent display provided at the windshield. Alternatively, the display unit 741 may include a projector module to output information via an image projected to the windshield.

The sound output unit 742 is configured to convert electrical signals from the controller 770 into audio signals and to output the audio signals. To this end, the sound output unit 742 may include, for example, a speaker. The sound output unit 742 may output sound corresponding to the operation of the user input unit 724.

The haptic output unit 743 is configured to generate tactile output. For example, the haptic output unit 743 may operate to vibrate a steering wheel, a safety belt, or a seat so as to allow the user to recognize an output thereof.

The vehicle drive unit 750 may control the operation of various devices of the vehicle. The vehicle drive unit 750 may include at least one of a power source drive unit 751, a steering drive unit 752, a brake drive unit 753, a lamp drive unit 754, an air conditioner drive unit 755, a window drive unit 756, an airbag drive unit 757, a sunroof drive unit 758, and a suspension drive unit 759.

The power source drive unit 751 may perform electronic control for a power source inside the vehicle 700.

For example, in the case where a fossil fuel based engine (not illustrated) is a power source, the power source drive unit 751 may perform electronic control for the engine. As such, the power source drive unit 751 may control, for example, an output torque of the engine. In the case where the power source drive unit 751 is the engine, the power source drive unit 751 may control the speed of the vehicle by controlling the output torque of the engine under the control of the controller 770.

In another example, when an electric motor (not illustrated) is a power source, the power source drive unit 751 may perform control for the motor. As such, the power source drive unit 751 may control, for example, the RPM and torque of the motor.

The steering drive unit 752 may include a steering apparatus. Thus, the steering drive unit 752 may perform electronic control for a steering apparatus inside the vehicle 700.

The brake drive unit 753 may perform electronic control of a brake apparatus (not illustrated) inside the vehicle 700. For example, the brake drive unit 753 may reduce the speed of the vehicle 700 by controlling the operation of brakes located at wheels. In another example, the brake drive unit 753 may adjust the direction of travel of the vehicle 700 leftward or rightward by differentiating the operation of respective brakes located at left and right wheels.

The lamp drive unit 754 may turn at least one lamp arranged inside and outside the vehicle 700 on or off. The lamp drive unit 754 may include a lighting apparatus. In addition, the lamp drive unit 754 may control, for example, the intensity and direction of light of each lamp included in the lighting apparatus. For example, the lamp drive unit 754 may perform control for a turn signal lamp, a headlamp or a brake lamp.

The air conditioner drive unit 755 may perform the electronic control of an air conditioner (not illustrated) inside the vehicle 700. For example, when the inside temperature of the vehicle 700 is high, the air conditioner drive unit 755 may operate the air conditioner to supply cold air to the inside of the vehicle 700.

The window drive unit 756 may perform the electronic control of a window apparatus inside the vehicle 700. For example, the window drive unit 756 may control the opening or closing of left and right windows of the vehicle 700.

The airbag drive unit 757 may perform the electronic control of an airbag apparatus inside the vehicle 700. For example, the airbag drive unit 757 may control an airbag to be deployed in a dangerous situation.

The sunroof drive unit 758 may perform electronic control of a sunroof apparatus inside the vehicle 700. For example, the sunroof drive unit 758 may control the opening or closing of a sunroof.

The suspension drive unit 759 may perform electronic control on a suspension apparatus (not shown). For example, when a road surface has a curve, the suspension drive unit 759 may control the suspension apparatus to reduce vibrations of a vehicle.

The memory 730 is electrically connected to the controller 770. The memory 730 may store basic data for each unit, control data for the operation control of the unit, and input/output data. The memory 730 may be various hardware storage devices such as, for example, a ROM, a RAM, an EPROM, a flash drive, and a hard drive. The memory 730 may store various data for the overall operation of the vehicle 700 such as, for example programs for the processing or control of the controller 770.

The interface unit 780 may serve as a passage for various kinds of external devices that are connected to the vehicle 700. For example, the interface unit 780 may have a port that is connectable to the mobile terminal 600 and may be connected to the mobile terminal 600 via the port. In this case, the interface unit 780 may exchange data with the mobile terminal 600.

Meanwhile, the interface unit 780 may serve as a passage for the supply of electrical energy to the connected mobile terminal 600. When the mobile terminal 600 is electrically connected to the interface unit 780, the interface unit 780 supplies electrical energy from the power source unit 790 to the mobile terminal 600 under the control of the controller 770.

The controller 770 may control the overall operation of each unit inside the vehicle 700. The controller 770 may be referred to as an Electronic Control Unit (ECU).

The controller 770 may execute a function corresponding to an execution signal delivered from the control device 100.

The controller 770 may be implemented in a hardware manner using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

The controller 770 may play the role of the processor 170 described above. That is, the processor 170 of the control device 100 may directly set in the controller 770 of the vehicle. In this embodiment, the control device 100 may be understood to designate a combination of some components of the vehicle.

Further, the controller 770 may control components to transmit information requested by the processor 170.

The power source unit 790 may supply power required to operate the respective components under the control of the controller 770. In particular, the power source unit 790 may receive power from, for example, a battery (not illustrated) inside the vehicle 700.

The AVN apparatus 400 may exchange data with the controller 770. The controller 770 may receive navigation information from the AVN apparatus 400 or a separate navigation apparatus (not illustrated). Here, the navigation information may include set destination information, destination based routing information, and map information or vehicle location information related to vehicle traveling.

Referring to FIG. 3, the vehicle control device 100 may include an input unit 110, a communication unit 120, an interface 130, a memory 140, a sensor unit 155, a monitoring unit 165, a processor 170, a display unit 180, an audio output unit 185, and a power supply unit 190. However, the units of the vehicle control device 100 of FIG. 3 are unnecessary to realize the vehicle control device 100. Thus, the vehicle control device 100 described in this specification may include additional components in addition to the above-described components, or a portion of the above-described components may be omitted.

Each component will now be described in detail. The vehicle control device 100 may include the input unit 110 for receiving user input.

For example, a user may input setting/execution of the vehicle surrounding image display function and the self-driving function, which are provided by the vehicle control device 100, or may input execution of power on/off of the vehicle control device 100 through the input unit 110.

The input unit 110 may include at least one of a gesture input unit (e.g., an optical sensor, etc.) for sensing a user gesture, a touch input unit (e.g., a touch sensor, a touch key, a push key (mechanical key), etc.) for sensing touch and a microphone for sensing voice input and receive user input.

Next, the vehicle control device 100 may include the communication unit 120 for communicating with another vehicle 510, a terminal 600 and a server 500.

The communication unit 120 may receive changed information in outer appearance of the vehicle or vehicle surrounding information from an object mounted on the outside of the vehicle or a structure for mounting the object. Also, the vehicle control device 100 may display the vehicle surrounding image on the basis of the changed information in outer appearance of the vehicle and the vehicle surrounding information and provide the self-driving function.

In detail, the communication unit 120 may receive at least one of position information, weather information and road traffic condition information (e.g., transport protocol experts group (TPEG), etc.) from the mobile terminal 600 and/or the server 500.

The communication unit 120 may receive traffic information from the server 500 having an intelligent traffic system (ITS). Here, the traffic information may include traffic signal information, lane information, vehicle surrounding information or position information.

In addition, the communication unit 120 may receive navigation information from the server 500 and/or the mobile terminal 600. Here, the navigation information may include at least one of map information related to vehicle driving, lane information, vehicle position information, set destination information and route information according to the destination.

For example, the communication unit 120 may receive the real-time position of the vehicle as the navigation information. In detail, the communication unit 120 may include a global positioning system (GPS) module and/or a Wi-Fi (Wireless Fidelity) module and acquire the position of the vehicle.

In addition, the communication unit 120 may receive driving information of the other vehicle 510 from the other vehicle 510 and transmit information on this vehicle, thereby sharing driving information between vehicles. Here, the shared driving information may include vehicle traveling direction information, position information, vehicle speed information, acceleration information, moving route information, forward/reverse information, adjacent vehicle information and turn signal information.

In addition, when a user rides in the vehicle, the mobile terminal 600 of the user and the vehicle control device 100 may pair with each other automatically or by executing a user application.

The communication unit 120 may exchange data with the other vehicle 510, the mobile terminal 600 or the server 500 in a wireless manner.

In detail, the communication unit 120 may perform wireless communication using a wireless data communication method. As the wireless data communication method, technical standards or communication methods for mobile communications (for example, Global System for Mobile Communication (GSM), Code Division Multiple Access (CDMA), CDMA2000 (Code Division Multiple Access 2000), EV-DO (Evolution-Data Optimized), Wideband CDMA (WCDMA), High Speed Downlink Packet Access (HSDPA), HSUPA (High Speed Uplink Packet Access), Long Term Evolution (LTE), LTE-A (Long Term Evolution-Advanced), and the like) may be used.

The communication unit 120 is configured to facilitate wireless Internet technology. Examples of such wireless Internet technology include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like.

In addition, the communication unit 120 is configured to facilitate short-range communication. For example, short-range communication may be supported using at least one of Bluetooth™, Radio Frequency IDentification (RFID), Infrared Data Association (IrDA), Ultra-Wideband (UWB), ZigBee, Near Field Communication (NFC), Wireless-Fidelity (Wi-Fi), Wi-Fi Direct, Wireless USB (Wireless Universal Serial Bus), and the like.

In addition, the vehicle control device 100 may pair with the mobile terminal located inside the vehicle using a short-range communication method and wirelessly exchange data with the other vehicle 510 or the server 500 using a long-distance wireless communication module of the mobile terminal.

Next, the vehicle control device 100 may include the interface 130 for receiving data of the vehicle and transmitting a signal processed or generated by the processor 170.

In detail, the vehicle control device 100 may receive at least one of driving information of another vehicle, navigation information and sensor information via the interface 130.

In addition, the vehicle control device 100 may transmit a control signal for executing a driving assistance function or information generated by the vehicle control device 100 to the controller 770 of the vehicle via the interface 130.

To this end, the interface 130 may perform data communication with at least one of the controller 770 of the vehicle, an audio-video-navigation (AVN) apparatus 400 and the sensing unit 760 using a wired or wireless communication method.

In detail, the interface 130 may receive navigation information by data communication with the controller 770, the AVN apparatus 400 and/or a separate navigation apparatus.

In addition, the interface 130 may receive sensor information from the controller 770 or the sensing unit 760.

Here, the sensor information may include at least one of vehicle traveling direction information, vehicle position information, vehicle speed information, acceleration information, vehicle tilt information, forward/reverse information, fuel information, information on a distance from a preceding/rear vehicle, information on a distance between a vehicle and a lane and turn signal information, etc.

The sensor information may be acquired from a heading sensor, a yaw sensor, a gyro sensor, a position module, a vehicle forward/reverse sensor, a wheel sensor, a vehicle speed sensor, a vehicle tilt sensor, a battery sensor, a fuel sensor, a tire sensor, a steering sensor on the basis of rotation of the steering wheel, a vehicle inside temperature sensor, a vehicle inside humidity sensor, a door sensor, etc. The position module may include a GPS module for receiving GPS information.

The interface 130 may receive user input via the user input unit 110 of the vehicle. The interface 130 may receive user input from the input unit of the vehicle or via the controller 770. That is, when the input unit is provided in the vehicle, user input may be received via the interface 130.

In addition, the interface 130 may receive traffic information acquired from the server. The server 500 may be located at a traffic control surveillance center for controlling traffic. For example, when traffic information is received from the server 500 via the communication unit 120 of the vehicle, the interface 130 may receive traffic information from the controller 770.

Next, the memory 140 may store a variety of data for overall operation of the vehicle control device 100, such as a program for processing or control of the controller 170.

In addition, the memory 140 may store data and commands for operation of the vehicle control device 100 and a plurality of application programs or applications executed in the vehicle control device 100. At least some of such application programs may be downloaded from an external server through wireless communication. At least one of such application programs may be installed in the vehicle control device 100 upon release, in order to provide the basic function (e.g., the driver assistance information guide function) of the vehicle control device 100.

Such application programs may be stored in the memory 140 and may be executed to perform operation (or function) of the vehicle control device 100 by the processor 170.

The memory 140 may store data for checking an object included in an image. For example, the memory 140 may store data for checking a predetermined object using a predetermined algorithm when the predetermined object is detected from an image of the vicinity of the vehicle acquired through the camera 160.

For example, the memory 140 may store data for checking the object using the predetermined algorithm when the predetermined algorithm such as a lane, a traffic sign, a two-wheeled vehicle and a pedestrian is included in an image acquired through the camera 160.

The memory 140 may be implemented in a hardware manner using at least one selected from among a flash memory, a hard disk, a solid state drive (SSD), a silicon disk drive (SDD), a micro multimedia vehicled, a vehicled type memory (e.g., an SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk and an optical disc.

In addition, the vehicle control device 100 may operate in association with a network storage for performing a storage function of the memory 140 over the Internet.

Next, the monitoring unit 165 may acquire information on the internal state of the vehicle.

The information detected by the monitoring unit may include at least one of facial recognition information, fingerprint information, iris-scan information, retina-scan information, hand geo-metry information, and voice recognition information. The monitoring unit may include other sensors for sensing such biometric recognition information.

Next, the vehicle control device 100 may further include the sensor unit 155 for sensing objects located in the vicinity of the vehicle. The vehicle control device 100 may include the sensor unit 155 for sensing peripheral objects and may receive the sensor information obtained by the sensor unit 155 of the vehicle via the interface 130. The acquired sensor information may be included in the information on the vehicle surrounding information.

The sensor unit 155 may include at least one of a distance sensor 150 for sensing the position of an object located in the vicinity of the vehicle and a camera 160 for capturing the image of the vicinity of the vehicle.

First, the distance sensor 150 may accurately detect the position of the object located in the vicinity of the vehicle, a distance between the object and the vehicle, a movement direction of the object, etc. The distance sensor 150 may continuously measure the position of the sensed object to accurately detect change in positional relationship with the vehicle.

The distance sensor 150 may detect the object located in at least one of the front, rear, left and right areas of the vehicle. The distance sensor 150 may be provided at various positions of the vehicle.

In detail, referring to FIG. 3, the distance sensor 150 may be provided at at least one of the front, rear, left and right sides and ceiling of the vehicle.

The distance sensor 150 may include at least one of various distance measurement sensors such as a Lidar sensor, a laser sensor, an ultrasonic wave sensor and a stereo camera.

For example, the distance sensor 150 is a laser sensor and may accurately measure a positional relationship between the vehicle and the object using a time-of-flight (TOF) and/or a phase-shift method according to a laser signal modulation method.

Information on the object may be acquired by analyzing the image captured by the camera 160 at the processor 170.

In detail, the vehicle control device 100 may capture the image of the vicinity of the vehicle using the camera 160, analyze the image of the vicinity of the vehicle using the processor 170, detect the object located in the vicinity of the vehicle, determine the attributes of the object and generate sensor information.

The image information is at least one of the type of the object, traffic signal information indicated by the object, the distance between the object and the vehicle and the position of the object and may be included in the sensor information.

In detail, the processor 170 may detect the object from the captured image via image processing, track the object, measure the distance from the object, and check the object to analyze the object, thereby generating image information.

The camera 160 may be provided at various positions.

In detail, the camera 160 may include an internal camera 160f for capturing an image of the front side of the vehicle within the vehicle and acquiring a front image.

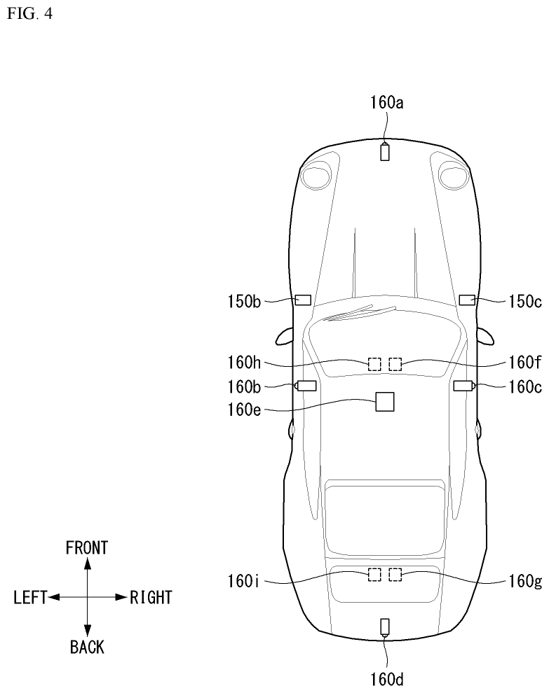

Referring to FIG. 4, a plurality of cameras 160 may be provided at least one of the front, rear, right and left and ceiling of the vehicle.

In detail, the left camera 160b may be provided inside a case surrounding a left side view mirror. Alternatively, the left camera 160b may be provided outside the case surrounding the left side view mirror. Alternatively, the left camera 160b may be provided in one of a left front door, a left rear door or an outer area of a left fender.

The right camera 160c may be provided inside a case surrounding a right side view mirror. Alternatively, the right camera 160c may be provided outside the case surrounding the right side view mirror. Alternatively, the right camera 160c may be provided in one of a right front door, a right rear door or an outer area of a right fender.

In addition, the rear camera 160d may be provided in the vicinity of a rear license plate or a trunk switch. The front camera 160a may be provided in the vicinity of an emblem or a radiator grill.

The processor 170 may synthesize images captured in all directions and provide an around view image viewed from the top of the vehicle. Upon generating the around view image, boundary portions between the image regions occur. Such boundary portions may be subjected to image blending for natural display.

In addition, the ceiling camera 160e may be provided on the ceiling of the vehicle to capture the image of the vehicle in all directions.

The camera 160 may directly include an image sensor and an image processing module. The camera 160 may process a still image or a moving image obtained by the image sensor (e.g., CMOS or CCD). In addition, the image processing module processes the still image or the moving image acquired through the image sensor, extracts necessary image information, and delivers the extracted image information to the processor 170.

In order to enable the processor 170 to more easily perform object analysis, for example, the camera 160 may be a stereo camera for capturing an image and, at the same time, measuring a distance from an object.

The sensor unit 155 may be a stereo camera including the distance sensor 150 and the camera 160. That is, the stereo camera may acquire an image and, at the same time, detect a positional relationship with the object.

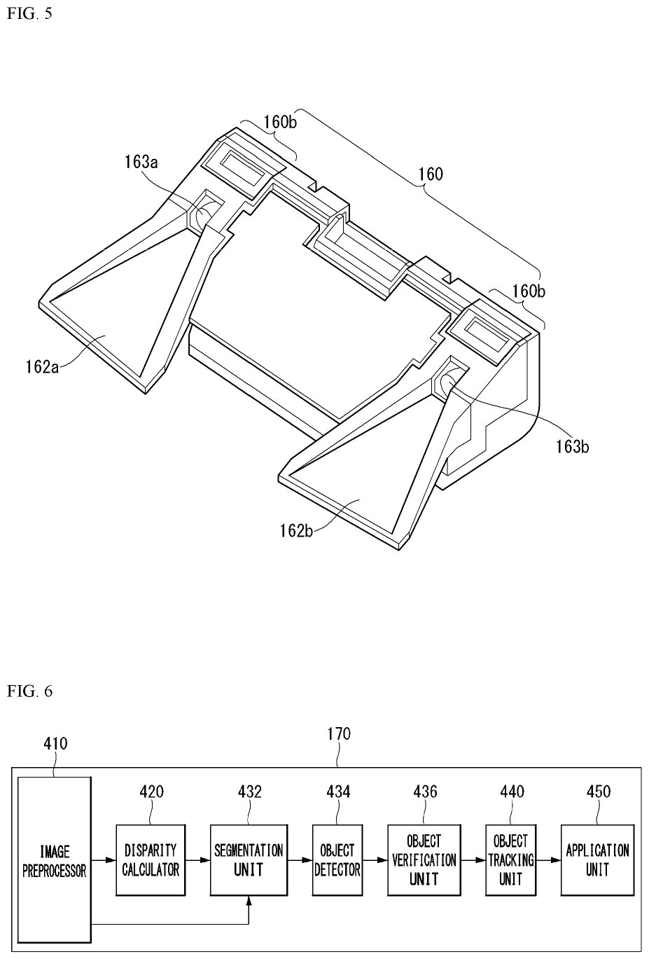

Referring to FIGS. 5, 6, and 7, the stereo camera 160 and a method by which the processor 170 detects image information using the stereo camera will be described in more detail.

Referring to FIG. 5, the stereo camera 160 may include a first camera 160a having a first lens 163a and a second camera 160b having a second lens 163b.

Meanwhile, the vehicle driving assistance apparatus may further includes a first light shield 162a and a second light shield 162b for shielding light incident on the first lens 163a and the second lens 163b, respectively.

This vehicle driving assistance apparatus may obtain a stereo image of the surroundings of the vehicle from the first and second cameras 160a and 160b, perform disparity detection on the basis of the stereo image, detect an object from at least one stereo image on the basis of disparity information, and continue to track movement of the object after the object is detected.

Referring to FIG. 6, an example of an internal block diagram of the processor 170 is illustrated, and the processor 170 in the control device 100 may include an image preprocessor unit 410, a disparity calculator 420, an object detector 434, an object tracking unit 440, and an application unit 450. In FIG. 5 and the following description, it is described that an image is processed in the order of the image preprocessor unit 410, the disparity calculator 420, the object detector 434, the object tracking unit 440, and the application unit 450, but aspects of the present invention are not limited thereto.

The image preprocessor 410 may receive an image from the camera 160 and performs preprocessing on the received image.

Specifically, the image preprocessor 410 may perform noise reduction, rectification, calibration, color enhancement, color space conversion (CSC), interpolation, camera gain control of the camera 160 in regard to an image. Accordingly, it is possible to acquire an image clearer than a stereo image photographed by the camera 160

The disparity calculator 420 may receive an image signal-processed in the image preprocessor 410, perform stereo matching on received images, and acquire a disparity map as a result of the stereo matching. That is, it is possible to acquire disparity information regarding stereo images of an area in front of a vehicle.

Here, the stereo matching may be performed in a pixel unit or a predetermined block unit of stereo images. Meanwhile, the disparity map may refer to a map that represents stereo images, that is, binocular parallax information of left and right images, as numeric values.

A segmentation unit 432 may perform segment and clustering regarding at least one image, based on disparity information received from the disparity calculator 420.

Specifically, the segmentation unit 432 may segment at least one stereo image into a background and a foreground, based on disparity information.

For example, an area having disparity information equal to or smaller than a predetermined value in a disparity map may be calculated as a background and excluded. Accordingly, the foreground may appear to be segmented. In another example, an area having disparity information equal to or greater than a predetermined value in a disparity map may be calculated as a foreground and extracted. Accordingly, the foreground may be segmented.

As such, a foreground and a background are segmented based on disparity information extracted based on a stereo images, and thus, if an object is detected later on, the speed for signal processing, a computation amount for signal processing, and the like may be reduced.

Next, the object detector 434 may detect an object on the basis of image segmentation by the segmentation unit 432.

That is, the object detector 434 may detect an object from at least one image, based on disparity information.

Specifically, the object detector 434 may detect an object from at least one image. For example, an object may be detected from a foreground segmented through image segmentation.

Next, the object verification unit 436 may classify and verify the segmented object.

To this end, the object verification unit 436 may employ a verification scheme using a neural network, a Support Vector Machine (SVM) scheme, a verification scheme by AdaBoost based on Haar-like features, a Histogram of Oriented Gradients (HOG) scheme, or the like.

Meanwhile, the object verification unit 436 may verify an object by comparing a detected object with objects stored in the memory 140.

For example, the object verification unit 436 may verify a nearby vehicle, a lane, a road surface, a traffic sign, a dangerous area, a tunnel, etc. in the vicinity of the vehicle.

The object tracking unit 440 may track a verified object. For example, the object tracking unit may verify an object in stereo images acquired sequentially, calculate a motion or a motion vector of the verified object, and track movement and the like of the corresponding object based on the calculated motion or motion vector. Accordingly, it is possible to track a nearby vehicle, a lane, a road surface, a traffic sign, a dangerous area, a tunnel, etc. in the vicinity of the vehicle.

Next, the application unit 450 may calculate a level of danger of the vehicle based on various objects, such as a nearby vehicle, a lane, a road surface, a traffic sign, etc., which are located in the vicinity of the vehicle. In addition, it is possible to calculate a possibility to collide with a preceding vehicle, a possibility of slipping of the vehicle, etc.

In addition, the application unit 450 may output a message and the like as vehicle driving assistant information to inform a user of the level of danger, the possibility of collision, the possibility of slipping, and the like. Alternatively, the application unit may generate a control signal for controlling position or travel of the vehicle as vehicle control information.

Meanwhile, the image preprocessor 410, the disparity calculator 420, the segmentation unit 432, the object detector 434, the object verification unit 436, the object tracking unit 440, and the application unit 450 may be elements of an image processor in the processor 170.

Meanwhile, in some embodiments, the processor 170 may include only some of the image preprocessor 410, the disparity calculator 420, the segmentation unit 432, the object detector 434, the object verification unit 436, the object tracking unit 440, and the application unit 450. For example, if the camera 160 is implemented as a mono camera 160 or an around-view camera 160, the disparity calculator 420 may be excluded. In addition, in some embodiments, the segmentation unit 432 may be excluded.

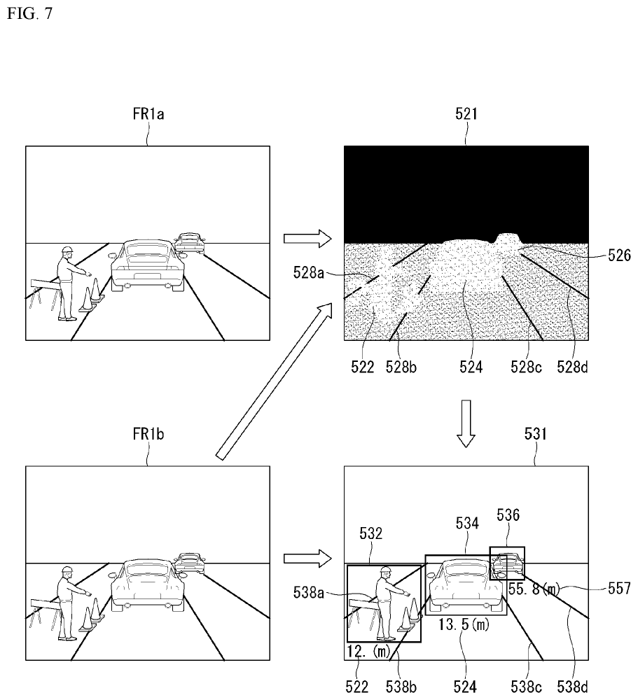

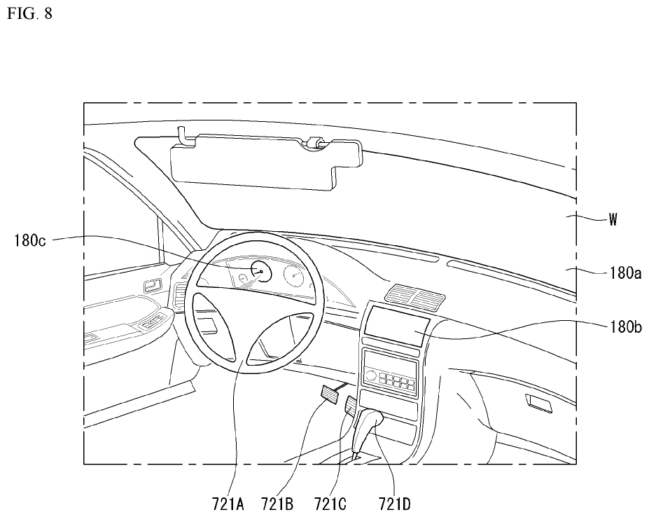

Referring to FIG. 7, the camera 160 may acquire stereo images during a first frame period.

The disparity calculator 420 in the processor 170 may receive stereo images FR1a and FR1b processed by the image preprocessor 410, and acquire a disparity map 520 by performing stereo matching on the received stereo images FR1a and FR1b.

The disparity map 520 indicates the levels of binocular parallax between the stereo images FR1 a and FR1 b, and, as a disparity level increases, a distance from a vehicle may decrease, and, as the disparity level decreases, the distance from the vehicle may increase.

When such a disparity map is displayed, luminance may increase as the disparity level increases, and luminance may decrease as the disparity level decreases.

In the drawing, disparity levels respectively corresponding to first to fourth lanes 528a, 528b, 528c and 528d and disparity levels respectively corresponding to a construction area 522, a first preceding vehicle 524 and a second preceding vehicle 526 are included in the disparity map 520.

The segmentation unit 432, the object detector 434 and the object verification unit 436 perform segmentation, object detection and object verification with respect to at least one of the stereo images FR1a and FR1b based on the disparity map 520.

In the drawing, object detection and verification are performed with respect to the second stereo image FR1b using the disparity map 520.

That is, object detection and verification are performed with respect to the first to fourth lanes 538a, 538b, 538c and 538d, the construction area 532, the first preceding vehicle 534 and the second preceding vehicle 536 of the image 530.

With image processing, the control device 100 may acquire various vehicle surrounding information, such as peripheral objects or the positions of the peripheral objects, using the sensor unit 155, as sensor information.

Next, the control device 100 may further include a display unit 180 which displays a graphic image. The display unit 180 may include a plurality of displays. The display unit 180 may include a first display unit 180a for projecting and displaying a graphic image onto and on a vehicle windshield W. That is, the first display unit 180a is a head up display (HUD) and may include a projection module for projecting the graphic image onto the windshield W. The graphic image projected by the projection module may have predetermined transparency. Accordingly, a user may simultaneously view the front and rear sides of the graphic image.

The graphic image may overlap the image projected onto the windshield W to achieve augmented reality (AR).

The display unit may include a second display unit 180b and a third display unit 180c separately provided inside the vehicle to display an image of the driver assistance function.

In more detail, the second display unit 180b may be a display or a center information display (CID) of a vehicle navigation apparatus. The third display unit 180c may be a cluster.

The second display unit 180b and the third display unit 180c may include at least one selected from among a Liquid Crystal Display (LCD), a Thin Film Transistor LCD (TFT LCD), an Organic Light Emitting Diode (OLED), a flexible display, a 3D display, and an e-ink display.

The second display unit 180b and the third display unit 180c may be combined with a gesture input unit to achieve a touchscreen.

Next, the audio output unit 185 may audibly output a message describing a function of the control device 100 and checking whether to perform the function. That is, the control device 100 may provide visual explanation of the function of the control device 100 via visual display of the display unit 180 and audio output of the audio output unit 185.

Next, the haptic output unit may output an alarm for the driver assistance function in a haptic manner. For example, the control device 100 may output vibration to the user when a warning is included in at least one of navigation information, traffic information, communication information, vehicle state information, advanced driver assistance system (ADAS) function and other driver convenience information.

The haptic output unit may provide directional vibration. For example, the haptic output unit may be provided in a steering apparatus for controlling steering to output vibration, and left or right vibration may be output according to the left and right sides of the steering apparatus to enable directional haptic output.

In addition, the power supply 190 may receive external power and internal power and supply power necessary for operation of the components under control of the processor 170.

The control device 100 may include the processor 170 for controlling overall operation of the units of the control device 100.

The processor 170 may take over the ole of the controller 770. That is, the processor 170 of the control device 100 may be set directly by the controller 770 of the vehicle. In such an embodiment, the control device3 100 may be interpreted as indicating a combination of some components of the vehicle. Alternatively, the processor 170 may control components to transmit information requested by the controller 770.

Further, the processor 170 may operate a combination of at least two of the components included in the control device 100, in order to execute the application program.

The processor 170 may be implemented in a hardware manner using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors 170, and electric units for the implementation of other functions.

The processor 170 may control overall operation of the control device 100 in addition to operation related to the application programs stored in the memory 140. The processor 170 may process signals, data, information, etc. via the above-described components or execute the application programs stored in the memory 140 to provide appropriate information or functions to the user.

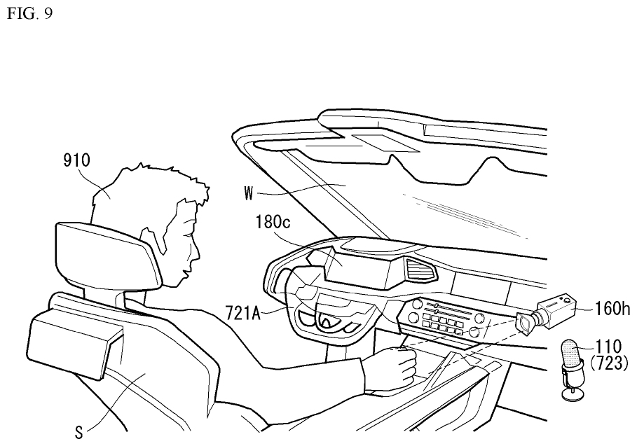

Referring to FIG. 9, a camera 160h may photograph the interior of a vehicle 700 and an occupant 900 present in the vehicle 700. Microphones 110 and 723 may receive a sound or voice generated inside the vehicle 700. The microphones 110 and 723 may be referred to as voice input units 110 and 723. The processor 170 may sense the interior of the vehicle 700 through the camera 160h. The processor 170 may sense a motion of the occupant 900 and a state of the occupant 900 through the camera 160h. The processor 170 may sense a voice of the occupant 900 through the microphone 160h. The processor 170 may be referred to as a controller 170.

An agent module 141 may be a program stored in the memory 140. The agent module 141 may be implemented by the processor 170. Alternatively, the agent module 141 may be a part of the processor 170 or may be the processor 170 itself. The processor 170 may receive a speaking of the occupant 900 through the microphone 110. The speaking of the occupant 900 may include a word, a phrase, and a sentence. The agent module 141 may generate a response to the speaking of the occupant 900. The processor 170 may output the response, generated by the agent module 141, in a form of conversation. The response of the processor 170 may be output as a sound through the audio output unit 185. The processor 170 may respond in a form of answering the speaking of the occupant 900. Alternatively, the processor 170 may respond in a form of displaying conversation, an image, a text, etc. on the display unit 180.

At least one word to search may be referred to as a query. The query may be referred to as a search query. In a case where the query is generated from the speaking of the occupant 900, the query may be referred to as a voice query. The query may include a plurality of words. When receiving the voice query, the processor 170 may convert the voice query into a text form.

The agent module 141 or the processor 170 may be provided with a function of providing a response to the query received from the occupant 900.

When receiving the voice query from the occupant 900 through the input unit 110, the agent module 141 or the processor 170 may convert the voice query into a text form. The processor 170 may perform a search for the query in a database of the memory 140, and output a search result.

Alternatively, when receiving the voice query from the occupant 900 through the input unit 110, the processor 170 may convert the voice query into a text form. The processor 170 may transmit the query to the server 500 through the communication unit 120. The query may be executed in a search engine of the server 500. The processor 170 may receive a search result from the server 500 through the communication unit 120. The processor 170 may output the received search result.

The agent module 141 or the processor 170 may extract a keyword from the speaking of the occupant 900. Alternatively, the agent module 141 or the processor 170 may infer a related keyword from the speaking of the occupant 900. The agent module 141 or the processor 170 may infer the related keyword in order to perform a speaking command of the occupant 900. A process of inferring the keyword may be performed by the agent module 141, the processor 170, or the server 500.

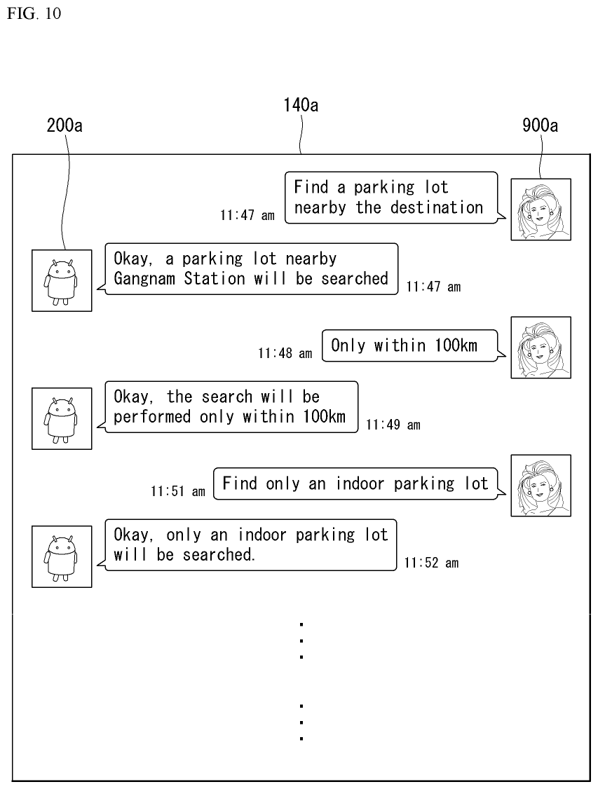

Referring to FIG. 10, the processor 170 may generate a dialogue 140a. The dialogue 140a may be stored speaking of the occupant 900 and a stored response of the processor 170 to the speaking of the occupant 900. The dialogue 140a may store the speaking of the occupant 900 and the response of the processor 170 in a text form. The dialogue 140a may store the speaking of the occupant 900 and the response of the processor 170 in chronological order. The dialogue 140a may store a content related to the speaking of the occupant or the response of the processor 170. The related content may be time information, image information, video information, travel information, vehicle location information, a destination, a start location, a waypoint, etc. The processor 170 may display a dialogue and a dialogue related content through the display unit 180.

A continuity between the speaking of the occupant 900 and the response of the processor 170 may be referred to as conversation or communication. The dialogue 140a may be stored conversation or communication.

The response of the processor 170 may be generated by the agent module 141 on its own. Alternatively, the processor 170 may transmit a speaking content of the occupant 900 to the outside through the communication unit 120 or may output a content received from the outside as a response to the speaking content of the occupant 900. For example, the processor 170 may transmit the speaking content of the occupant 900 to the server 500 through the communication unit 120. The server 500 may generate a content responsive to the speaking content of the occupant 900, and transmit the content to the processor 170. The processor 170 may output the content received from the server as a response to the speaking content of the occupant 900. Hereinafter, the responsive content of the processor 170 may include both a responsive content generated by the agent module 141 on its own and a responsive content received from the outside.

The travel information may include a travel mode of the vehicle 700, a state of the vehicle 700, a travel state, a direction of travel of the vehicle 700, a situation in the vicinity of the vehicle 700, a situation inside the vehicle 700, etc.

The travel mode may be differentiated depending on whether the traveling of the vehicle 700 is manually performed by a driver, whether the traveling of the vehicle 700 is automatically performed by the processor 170, or whether the traveling of the vehicle 700 is partially manually performed by the driver and partially automatically performed by the processor 170.

The processor 170 may display an image 140a of a dialogue through the display unit 180. The processor 170 may display a speaking content 900a of the occupant 900 and a response content 200a of the processor 170.

The processor 170 may activate or call the agent module 141 in accordance with a predetermined input. Alternatively, the processor may activate a function related to the dialogue. The predetermined input may include a voice input of speaking a specific content, a touch input, or a button input. For example, the predetermined input may be speaking “Hi, LG” of the occupant 900. The processor 170 may sense the predetermined input trough the microphone 110 or the camera 160h. When a predetermined period of time passes without speaking of the occupant 900, the processor 170 may deactivate the agent module 141.

When the predetermined input is received, the processor 170 may activate the microphone 110. When the predetermined input is received, the processor 170 may keep the microphone 110 activate for a predetermined period of time. When a predetermined period of time passes without a speaking of the occupant 900, the processor 170 may deactivate the microphone 110.

The memory 140 may store a plurality of dialogues. The processor may selectively and repeatedly load the plurality of dialogues stored in the memory 140.

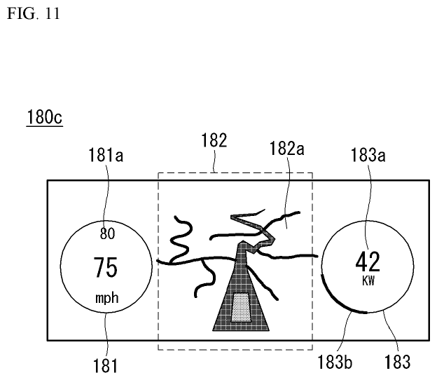

Referring to FIG. 11, the display unit 180c may display an image. The display unit 180c may be referred to as a cluster 180c. The cluster 180c may be divided into a first display area 181, a second display area 182, and a third display area 183 to display an image. The respective display areas 181, 182, and 183 may display different images.

The first display area 181 may display an image 181a related to speed of the vehicle 700. For example, the first display area 181 may display a current speed of the vehicle 700 and a speed limit on a road on which the vehicle 700 is traveling.

The second display area 182 may display navigation information 182. The second display area 182 may display a function related to autonomous travel of the vehicle 700. For example, an Advance Driver Assistance System (ADAS) system activated during traveling of the vehicle 700 may be displayed.

The third display area 183 may display information 183a and 183b related to electric power of the vehicle 700. For example, when the vehicle 700 is driven by an electric motor, the third display area 183 may display a numeric value 183a and a gauge 183b to represent a remaining capacity of a battery 790 of the vehicle 700.

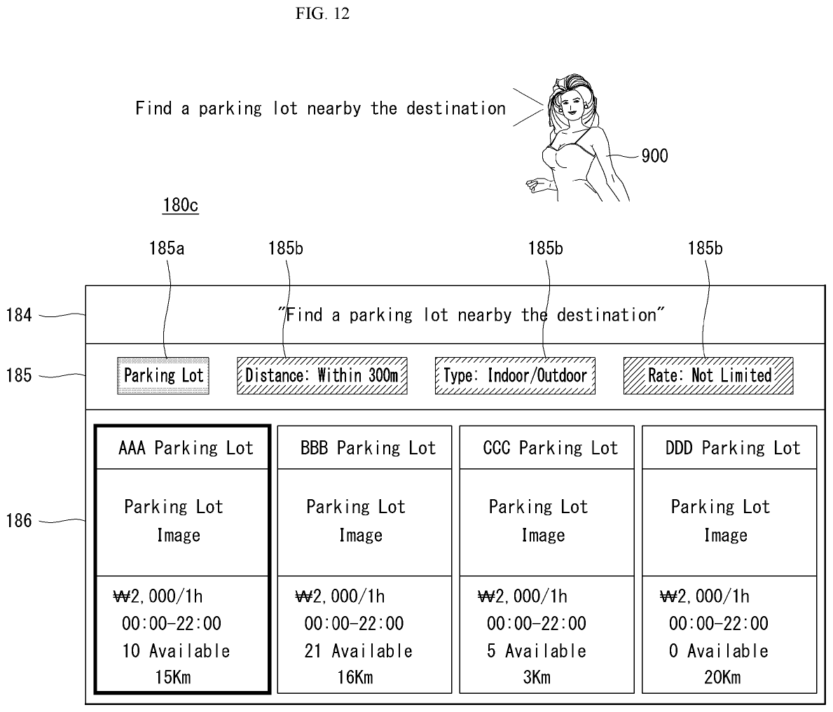

Referring to FIG. 12, the processor 170 may receive a voice query through a speaking of the occupant 900. The processor 170 may receive the voice query of the occupant 900 through the microphone 110. The processor 170 may display an image in response to the voice query.

The first display area 184 may display speaking content of the occupant 900, recognized by the processor 170, in a text form. The second display area 185 may display a keyword 185a recognized by the processor 170 from the speaking of the occupant 900. The second display area 185 may display a keyword 185b inferred from the speaking of the occupant 900. The third display area 186 may display a result of a search that is performed on the basis of the keyword 185a recognized from the speaking of the occupant 900 and the keyword inferred from the speaking of the occupant 900.

For example, the occupant 900 may speak “find a parking lot nearby the destination”. The processor 170 may extract and display a keyword “parking lot” from the speaking of the occupant 900. The processor 170 may acquire destination and route information of the vehicle 700 through navigation information. The processor 170 may infer a distance to the parking lot, a type of the parking lot, and a rate of the parking lot, etc. from the speaking of the occupant 900, and display the inferred information as the inferred keyword 185b. The keyword 185a recognized from the speaking of the occupant 900 and the keyword 185b inferred from the speaking of the occupant 900 may be displayed differently. For example, a letter font, a letter color, a letter size, a letter background pattern, a letter background color, and the like may be set differently. Alternatively, the keywords 185a and 185b may be displayed in backgrounds of bubble-shaped graphic images. In addition, related keywords may be displayed in association. In addition, the keywords 185a and 185b may be displayed in backgrounds of bubble-shaped graphic objects, and the bubble-shaped backgrounds of the related keywords may be connected.

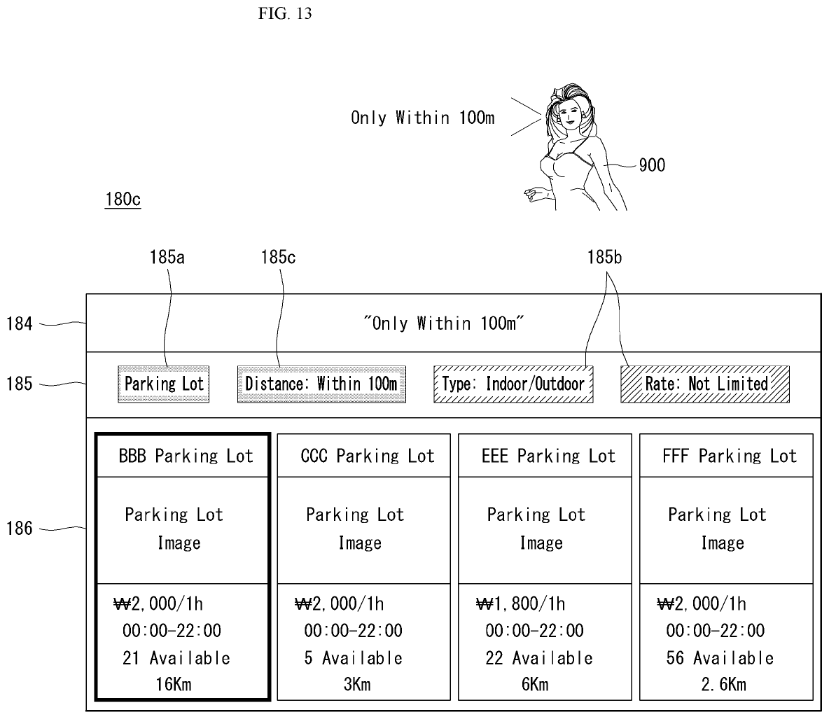

Referring to FIG. 13, the processor 170 may update a dialogue based on an additional speaking of the occupant 900. The processor 170 may update a keyword inferred from the additional speaking of the occupant 900.

For example, the occupant 900 may additionally speak “only with the radius of 100 m”. The processor 170 may extract and display a keyword “100 m” from the speaking of the occupant 900. The processor 170 may update an inferred keyword “distance: 300 m in the vicinity” into a keyword “distance: 100 m in the vicinity”. The processor 170 may display the updated keyword 185c to appear different from the keyword 185b that has not been updated since inference. For example, a letter font, a letter color, a letter size, a letter background pattern, a letter background color, etc. may be set differently. Alternatively, the keywords 185a, 185b, and 185c may be displayed in association. In addition, the keywords 185a, 185b, and 185c may be displayed in backgrounds of bubble-shaped graphic objects, and the bubble-shaped backgrounds of the related keywords may be connected.

The processor 170 may display, on the third display area 186, a result of a search that is performed on the basis of the keyword 185a recognized from the speaking of the occupant 900, the updated keyword 185c, and the keyword 185b that has not been updated since inference.

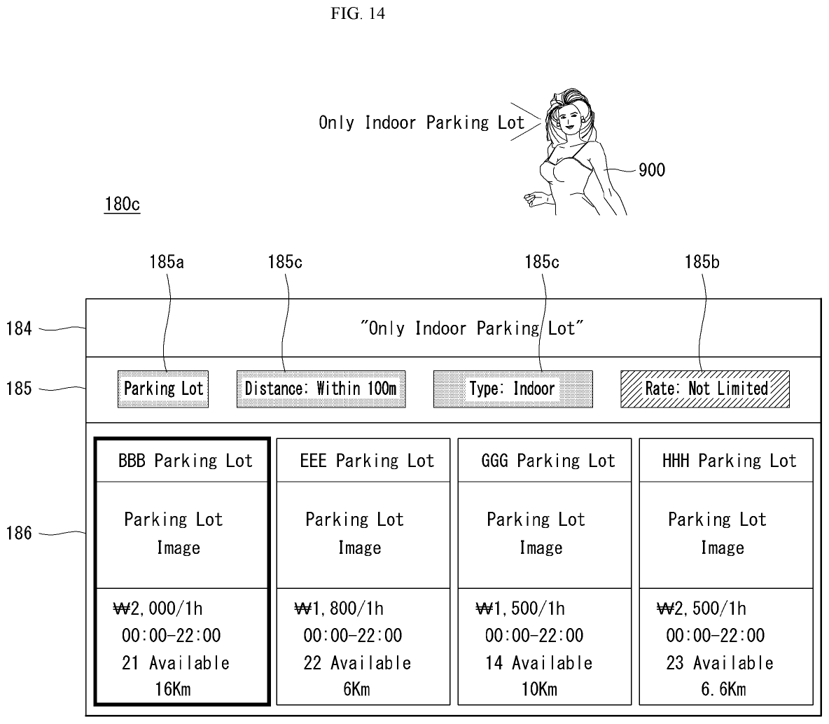

Referring to FIG. 14, the processor 170 may update a dialogue based on an additional speaking of the occupant 900. The processor 170 may update a keyword inferred from the additional speaking of the occupant 900.

For example, the occupant 900 may additionally speak “only an indoor parking lot”. The processor 170 may extract and display a keyword “indoor” from the speaking of the occupant 900. The processor 170 may update an inferred keyword “type: indoor/outdoor” into “type: indoor”. The processor 170 may display the updated keyword 185c to appear different from the keyword 185b that has not been updated since inference. For example, a letter font, a letter color, a letter size, a letter background pattern, a letter background color, etc. may be set differently. Alternatively, the keywords 185a, 185b, and 185c may be displayed in backgrounds of bubble-shaped graphic objects. In addition, the keywords 185a, 185b, and 185c may be displayed in association. In addition, the keywords 185a, 185b, and 185c may be displayed in backgrounds of bubble-shaped graphic objects, and the bubble-shaped backgrounds of the related keywords may be connected.

The processor 170 may display, on the third display area 186, a result of a search that is performed on the basis of the keyword 185a recognized from the speaking of the occupant 900, the updated keyword 185c, and the keyword 185b that has not been updated since inference.

When there is no result of the search performed on the basis of the speaking of the occupant 900, the processor 170 may display an image proposing a travel strategy to the occupant 900. For example, in order to find a result satisfying the speaking of the occupant, a travel strategy of increasing speed may be proposed. Travel strategies may be a travel primarily focused on safety, a travel primarily focused on fuel efficiency, a travel focused on the shortest path, and a travel focused on the minimum travel time.

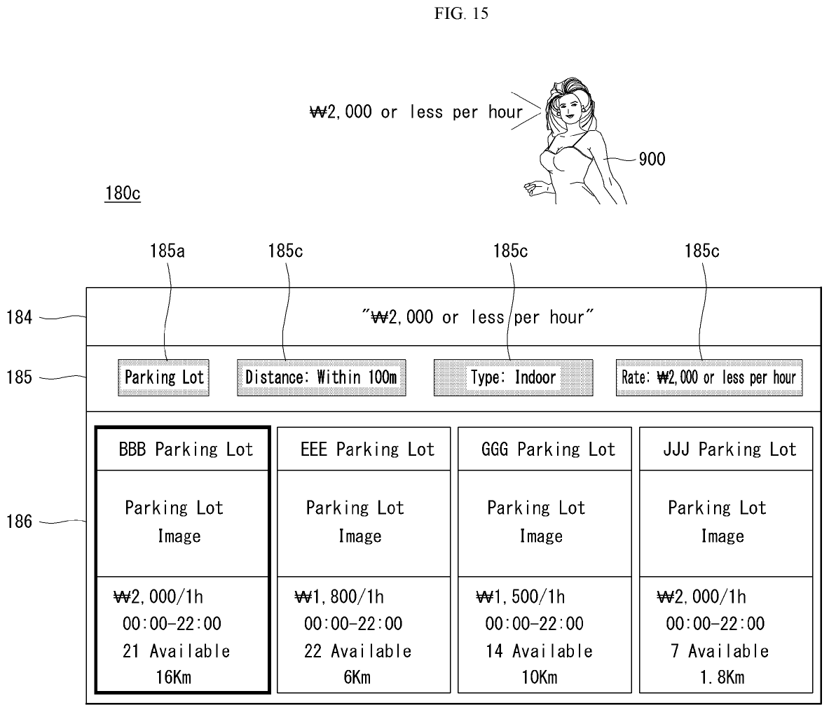

Referring to FIG. 15, the processor 170 may update a dialogue based on an additional speaking of the occupant 900. The processor 170 may update a keyword inferred from the additional speaking of the occupant 900.

For example, the occupant 900 may additionally speak “less than 2000 Won per hour”. The processor 170 may extract and display a keyword “2000 Won” from the speaking of the occupant 900. The processor 170 may update an inferred keyword “rate: not limited” into a keyword “rate: less than 2000 Won”. The processor 170 may display, on the third display area 186, a result of a search that is performed on the basis of the keyword 185a recognized from the speaking of the occupant 900 and the updated keyword 185c. The keywords 185a and 185c may be displayed in backgrounds of bubble-shaped graphic objects. In addition, the related keywords may be displayed in association. In addition, the keywords 185a and 185c may be displayed in backgrounds of bubble-shaped graphic objects, and the bubble-shaped backgrounds of the related keywords may be connected.

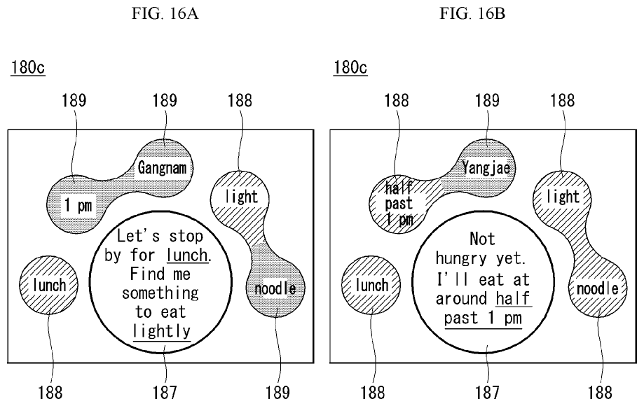

Referring to FIG. 16A, the processor 170 may receive a voice query through a speaking of the occupant 900. The processor 170 may receive the voice query of the occupant 900 through the microphone 110. The processor 170 may display an image corresponding to the voice query.

The first display area 187 may display speaking content of the occupant 900, recognized by the processor 170, as a text. The second display area 188 may display a keyword recognized by the processor 170 from the speaking of the occupant 900. The third display area 189 may display a keyword inferred from the speaking of the occupant 900.

For example, the occupant 900 may speak “Let's stop by for lunch. Find me something to eat lightly”. The processor 170 may extract and display 188 a keyword “lunch, lightly” from the speaking of the occupant 900. The processor 170 may infer a dish, a place, a time, etc. related to “lightly” from the speaking of the occupant 900, and display the inferred information as an inferred keyword 189. The keyword 188 recognized from the speaking of the occupant 900 and the keyword 189 inferred from the speaking of the occupant 900 may be displayed differently. For example, a letter font, a letter color, a letter size, a letter background pattern, a letter background color, etc. may be set differently. Alternatively, the keywords 188 and 189 may be displayed in backgrounds of bubble-shaped graphic objects. In addition, the related keywords may be displayed in association. In addition, the keywords 188 and 189 may be displayed in backgrounds of bubble-shaped graphic objects, and the bubble-shaped backgrounds of the related keywords may be connected.

Referring to FIG. 16B, the processor 170 may update a dialogue based on an additional speaking of the occupant 900. The processor 170 may update a keyword inferred from the additional speaking of the occupant 900.

For example, the occupant 900 may additionally speak “Not hungry yet. I'll eat at around half past 1 pm”. The processor 170 may extract and display a keyword “around half past 1 pm” from the speaking of the occupant 900. The processor 170 may acquire information regarding a destination, a waypoint, etc. of the vehicle 700 from the navigation apparatus of the vehicle 700, and may infer that the vehicle 700 is going to pass nearby Yang Jae at around half past 1 pm. The processor 170 may update “1 pm” into the keyword “half 1 pm” inferred from the speaking of the occupant 900, and display the updated keyword. The processor 170 may update an extracted keyword 189 of “Gangnam” into the inferred keyword 189 of “Yangjae”, and display the updated keyword. In addition, when the inference of the inferred keyword 189 of “noodle” is determined as absolutely correct information, the processor 170 may display the same as a decisive keyword 188.

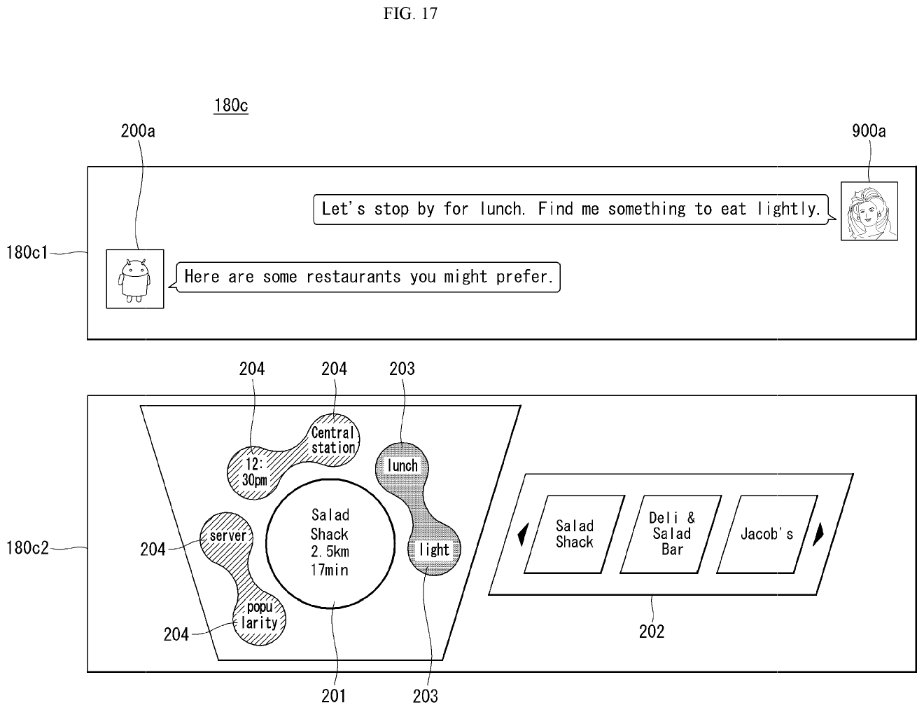

Referring to FIG. 17, the processor 170 may respond to a speaking or a voice query of the occupant 900 in a conversation manner. The processor 170 may display an image 180c1 in response to the speaking or voice query of the occupant 900. The image 180cl may show the speaking or voice query of the occupant 900 and the response of the processor 170 as distinguishable texts. In order to make the speaking or voice query of the occupant 900 and the response of the processor 170, the processor 170 may display an image 900a of the occupant 900 and an image 200a of the processor 170.

A first display area 203 may display a keyword recognized by the processor 170 from the speaking of the occupant 900. A second display area 204 may display a keyword inferred from the speaking of the occupant 900. A third display area 202 may display a plurality of results of a search that is performed on the basis of the keyword recognized from the speaking of the occupant 900 and the keyword inferred from the speaking of the occupant 900. A fourth display area 201 may display a search result that is closest to the intention of the speaking of the occupant from among the plurality of results displayed on the third display area 202.

For example, the occupant 900 may speak “Let's stop by for lunch. Find me something to eat lightly”. The processor 170 may extract a keyword “lunch, light” from the speaking of the occupant 900, and display an image 203. The processor 170 may infer a keyword related to time and place from the speaking of the occupant 900, and display an image 204. Alternatively, the processor 170 may display the image 204 to indicate that a keyword “popularity” has been inferred by the server 500. In the order according to “popularity”, the processor 170 may display, on the third display area 202, results of a search that is performed based on inferred keywords “12:30 pm, Central station” and the keyword “launch, light” recognized from the speaking. The processor may display, on the fourth display area 201, “Salad Shack” that is determined as a restaurant the most adequate to the criteria “popularity” among found restaurants”. The keyword 203 recognized from the speaking of the occupant 900 and the keyword 204 inferred from the speaking of the occupant 900 may be displayed differently. For example, a letter font, a letter color, a letter size, a letter background pattern, a letter background color, and the like may be set differently. Alternatively, the keywords 203 and 204 may be displayed in backgrounds of bubble-shaped graphic images. In addition, related keywords may be displayed in association. In addition, the keywords 203 and 204 may be displayed in backgrounds of bubble-shaped graphic objects, and the bubble-shaped backgrounds of the related keywords may be connected.

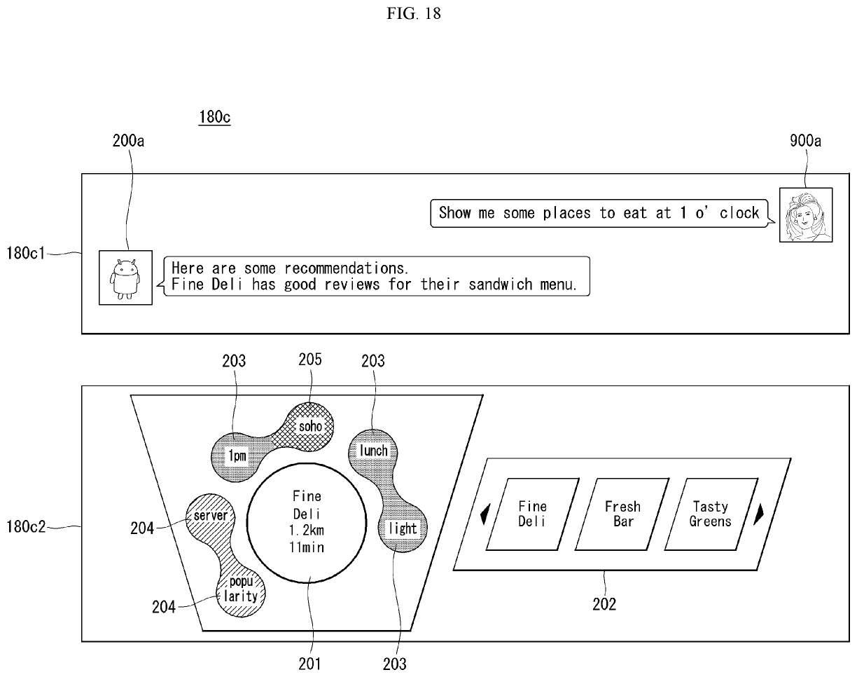

Referring to FIG. 18, the processor 170 may update a dialogue based on an additional speaking of the occupant 900. The processor 170 may update an inferred keyword from the additional speaking of the occupant 900.

For example, the occupant 900 may additionally speak “Show me some places to eat at 1 o'clock”. The processor 170 may extract and display a keyword “1 pm” from the speaking of the occupant 900. The processor 170 may acquire information on a destination, a route, etc. from the navigation apparatus of the vehicle 700, and may infer that the vehicle 700 is going to pass nearby Soho at around 1 pm. The processor 170 may update the inferred keyword 204 of “12:30 pm” into the keyword 203 of “1 pm” recognized from the speaking of the occupant 900, and may display the updated keyword. The processor 170 may update the inferred keyword 204 of “Central station: into an inferred keyword 205 of “Soho”, and display the updated keyword. If it is determined that the inference as to the inferred keyword 204 of “Soho” is not sure, the processor 170 may display the keyword 305. In the order according to “popularity”, the processor 170 may display, on the third display area 202, results of a search that is performed based on the inferred keyword “Soho” and the keyword “launch, light” recognized from the speaking. The processor may display, on the fourth display area 201, “Fine deli” that is determined as a restaurant the most adequate to the criteria “popularity” among found restaurants”.

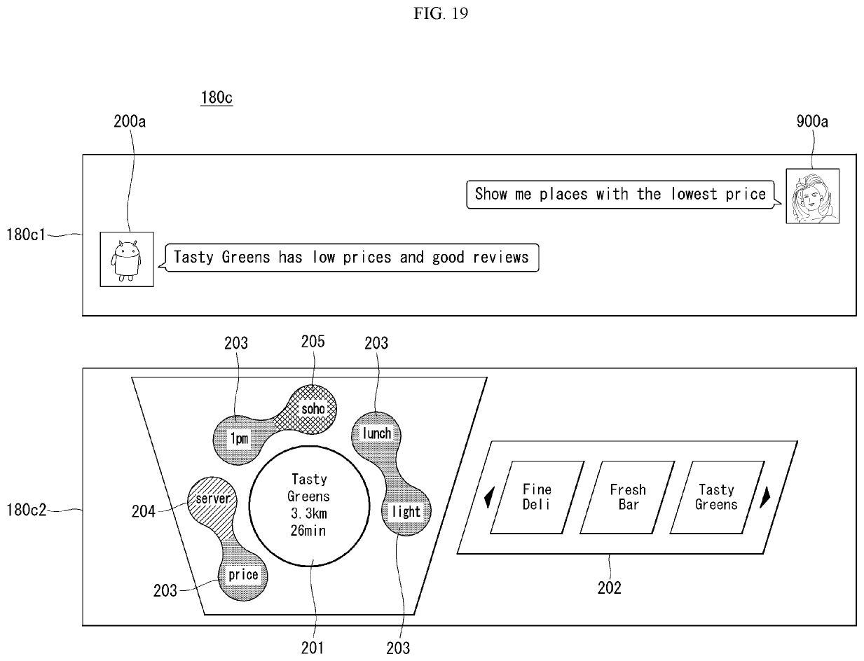

Referring to FIG. 19, the processor 170 may update a dialogue based on an additional speaking of the occupant 900. The processor 170 may update an inferred keyword from the additional speaking of the occupant 900.

For example, the occupant 900 may additionally speak “Show me places with the lowest price”. The processor 170 may extract a keyword “price” from the speaking of the occupant 900 and display the keyword. The processor 170 may display found restaurants on the third display area 202 in the order according to the inferred keyword “price”. The processor may display, on the fourth display area 201, “Tasty Greens” that is determined to be the most adequate to the criteria of “popularity” among the found restaurants.

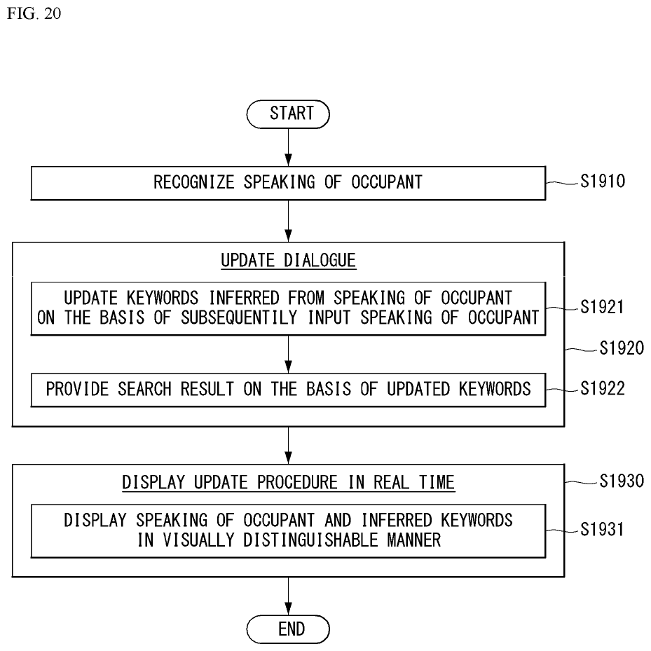

Referring to FIG. 20, the processor 170 may recognize a speaking of the occupant 900 (S1910). The processor 170 may update a dialogue based on the speaking of the occupant 900 (S1920). The step (S1920) of updating the dialogue includes a step (S1921) of updating a keyword, inferred from the speaking of the occupant, on the basis of a subsequently input speaking of the occupant 900, and a step (S1922) of providing results of a search performed on the basis of the updated keyword. The processor 170 may display in real time the procedure of updating the dialogue (S1930). A step of displaying in real time the procedure of updating the dialogue may include a step (S1931) of displaying the speaking of the occupant 900 and the inferred keyword in a visually distinguishable manner.

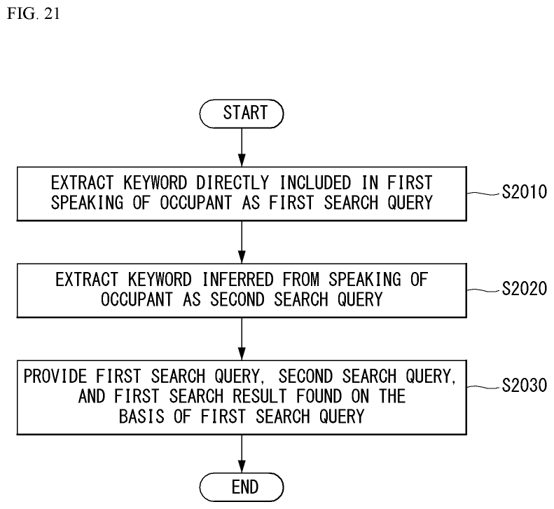

Referring to FIG. 21, the processor 170 may extract a keyword directly included in a first speaking of the occupant 900 as a first search query (S2010). The processor 170 may extract a keyword inferred from the speaking of the occupant 900 as a second search query (52020). The processor 170 may provide the first search query, the second search query, and a first search result found on the basis of the first search query (S2030).

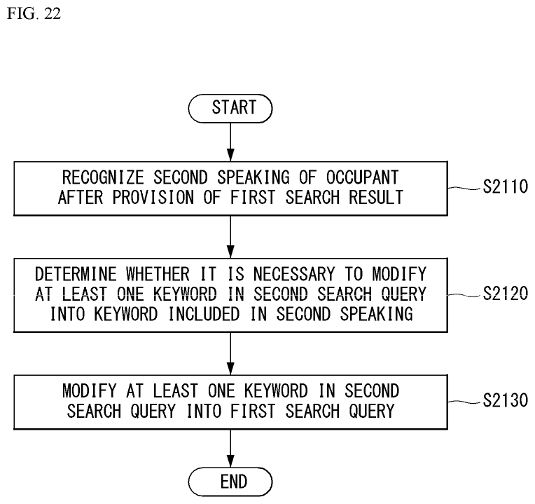

Referring to FIG. 22, after the first search result is provided, the processor 170 may recognize a second speaking of the occupant 900 (S2110). The processor 170 may determine whether it is necessary to modify at least one keyword in the second query into a keyword included in the second speaking (S2120). The processor 170 may modify at least one keyword in the second search query into a first search query (S2130).

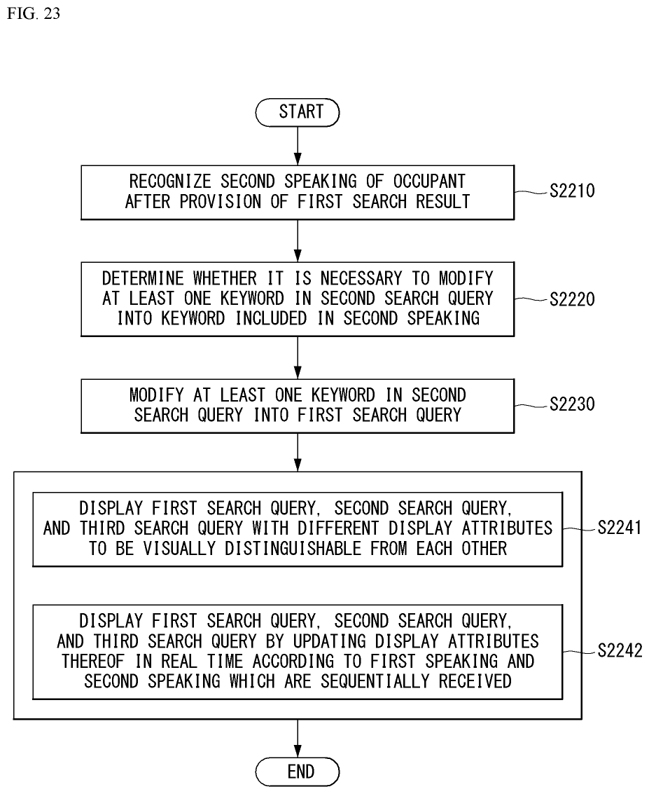

Referring to FIG. 23, after providing the first search result, the processor 170 may recognize a second speaking of the occupant (52210). The processor 170 may determine whether it is necessary to modify at least one keyword in the second search query into a keyword included in the second speaking (S2220). The processor 170 may modify at least one keyword in the second search query into a first search query (S2230). The processor 170 may display the first search query, the second search query, and a third search query with different display attributes so that the first search query, the second search query, and the third search query are temporally distinguishable from each other (S2241), or may display the first search query, the second search query, and the third search query by updating display attributes thereof in real time (S2242).

The present invention may include the following embodiments.

Embodiment 1: A control method for controlling a vehicle using an agent module generating a dialogue which constructs a dialogue-type response to a received speaking of an occupant, the method including: receiving the speaking of the occupant through a voice input unit; updating the dialogue as a procedure of providing a search result in response to a search request through the speaking of the occupant is performed multiple times; and displaying in real time, on a display, a procedure of updating the dialogue, wherein the updating of the dialogue includes: updating keywords, inferred from the speaking of the occupant, on the basis of a subsequently input speaking of the occupant; and providing the search result on the basis of the updated keywords, and wherein, in the displaying on the display, the keywords inferred from the speaking of the occupant through the agent module are displayed with different display attributes and thereby visually distinguishable from each other.

Embodiment 2: The control method regarding Embodiment 1, wherein the updating of the dialogue further includes: extracting at least one keyword directly included in a first speaking of the occupant as a first search query; extracting at least one keyword inferred from the speaking of the occupant as a second search query; and displaying the first search query, the second search query, and a first search result found on the basis of the first search query.

Embodiment 3: The control method of Embodiment 2, further comprising: after the first search result is provided, receiving a second speaking of the occupant; and when it is determined based on the second speaking that it is necessary to modify at least one keyword in the second query into a keyword included in the second speaking, modifying the at least one keyword in the second query into the first search query.

Embodiment 4: The control method of Embodiment 3, further including: when it is determined based on the second speaking that it is necessary to re-infer at least one keyword in the second search query, re-inferring the at least one keyword in the second search query and converting the re-inferred at least one keyword into a third search query; and displaying, on the display, a second search result found on the basis of the updated first search query.

Embodiment 5: The control method of Embodiment 4, wherein, in the displaying on the display, the first search query, the second search query, and the third search query are displayed with different display attributes and thereby visually distinguishable from each other.

Embodiment 6: The control method of Embodiment 5, wherein, in the displaying on the display, the first search query, the second search query, and the third search query are displayed in different colors.

Embodiment 7: The control method of Embodiment 5, wherein, in the displaying on the display, the first search query, the second search query, and the third search query are displayed by updating display attributes thereof in real time according to the first speaking and the second speaking which are sequentially received.

Embodiment 8: The control method of Embodiment 2, further comprising displaying the dialogue on the display, wherein a dialogue window for displaying conversation between the occupant and the agent module, and the search result are displayed together.

Embodiment 9: The control method of Embodiment 8, wherein the search result provides a list comprising at least one image or at least one text corresponding to the search result.

Embodiment 10: The control method of claim 8, further including: recognizing the speaking of the occupant and converting the speaking into a first text; through the agent module, generating a response to the speaking of the occupant or a second text explaining the search result; and, through a voice output unit, outputting at least a part of the second text, wherein the dialogue window is divided into a first area for selectively displaying the first text and the second text and a second area for displaying the first search query and the second search query, the second area which excludes the first area.

Embodiment 11: The control method of Embodiment 10, wherein the first text displayed in the first area comprises an entire of the speaking of the occupant, and at least a part of the second text is displayed in the first area as a text, an image, or a graphic object.

Embodiment 12: The control method of Embodiment 10, wherein the first area is a circular graphic object.

Embodiment 13: The control method of Embodiment 10, wherein the first search query and the second search query are represented by bubble-shaped graphic objects, wherein keywords of a search query are displayed within independent bubbles, and wherein when the respective keywords are extracted by an identical criteria or similar criterion, at least a part of a bubble of each of the respective keywords is connected to each other.

Embodiment 14: The control method of Embodiment 13, wherein a criteria for extracting the keywords comprises at least one of a route, location information, time, speaking content of the occupant, or a search source.

Embodiment 15: The control method of Embodiment 2, wherein at least one keyword forming the second search query comprises a keyword extracted by the agent module or received from an external server through a wireless communication unit.

Embodiment 16: A control device comprising: a display; a voice input unit receiving a speaking of an occupant; an agent module generating a dialogue with a dialogue-type response to the received speaking of the occupant; and a controller, wherein the dialogue is constructed of a search request through the speaking of the occupant and a search result provided by the agent module, and the controller displays, on the display, a procedure of updating the dialogue, as a procedure of speaking by the occupant and providing a search result by the agent modules is performed multiple times, wherein the agent module updates keywords, inferred from the speaking of the occupant, on the basis of a subsequently input speaking of the occupant, and provides a search result on the basis of the updated keywords, and wherein the controller displays the keywords, inferred from the speaking of the occupant through the agent module, with different display attributes and thereby visually distinguishable from each other.

Embodiment 17: The control device of Embodiment 16, wherein the agent module extracts at least one keyword directly included in a first speaking of the occupant as a first search query, and extracts at least one keyword inferred from the speaking of the occupant as a second search query, and wherein the controller displays, on the display, the first search query, the second search query, and a first search result found on the basis of the first search query.

Embodiment 18: The control device of Embodiment 17, wherein the agent module recognizes a second speaking of the occupant after the provision of the first search result, and, when it is determined based on the second speaking that it is necessary to modify at least one keyword in the second search query into a keyword included in the second speaking, the agent module modifies the at least one keyword in the second search query into the first search query.

Embodiment 19: The control device of Embodiment 18, wherein when it is determined based on the second speaking it is necessary to re-infer at least one keyword in the second search query, the agent module re-infers the at least one keyword in the second search query and extract the re-inferred at least one keyword as a third search query, and wherein the controller displays, on the display, a second search result found on the basis of the updated first search query.

Embodiment 20: The control device of Embodiment 19, wherein the controller performs a control operation such that the first search query, the second search query, and the first search result found on the basis of the first search query are displayed with different display attributes and thereby visually distinguishable from each other.

Embodiment 21: The control device of Embodiment 20, wherein the controller performs control such that the first search query, the second search query, and the third search query are displayed in different colors.

Embodiment 22: The control device of Embodiment 20, wherein the controller displays the first search query, the second search query, and the third search query by updating display attributes thereof in real time according to the first speaking and the second speaking which are sequentially received.

Embodiment 23 The control device of Embodiment 17, wherein the controller displays the dialogue on the display, wherein a dialogue window for displaying conversation between the occupant and the agent module, and the search result are displayed together.

Embodiment 24: The control device of Embodiment 23, wherein the search result provides a list comprising at least one image or at least one text corresponding to the search result.

Embodiment 25: The control device of Embodiment 23, wherein the controller recognizes the speaking of the occupant and converts the speaking into a first text, generates a response to the speaking of the occupant or a second text explaining the search result through the agent module, and outputs at least a part of the second text through a voice output unit, and wherein the dialogue window is divided into a first area for selectively displaying the first text and the second text and a second area for displaying the first search query and the second search query, the second area which excludes the first area.

Embodiment 26: The control device of Embodiment 25, wherein the first text displayed in the first area comprises an entire of the speaking of the occupant, and at least a part of the second text is displayed in the first area as a text, an image, or a graphic object.

Embodiment 27: The control device of Embodiment 25, wherein the first area is a circular graphic object.

Embodiment 28: The control device of Embodiment 25, wherein the first search query and the second search query are represented by bubble-shaped graphic objects, wherein keywords of a search query are displayed within independent bubbles, and wherein when the respective keywords are extracted by an identical criteria or similar criterion, at least a part of a bubble of each of the respective keywords is connected to each other.

Embodiment 29: The control device of Embodiment 28, wherein a criteria for extracting the keywords comprises at least one of a route, location information, time, speaking content of the occupant, or a search source.

Embodiment 30: The control device of Embodiment 17, wherein at least one keyword forming the second search query comprises a keyword extracted by the agent module or received from an external server through a wireless communication unit.

The control device according to the present invention have effects as follows. According to at least one of the embodiments of the present invention, a control device for driving assistance of a vehicle may be provided. According to at least one of the embodiments of the present invention, a control device enabling conversation with an occupant during traveling may be provided. According to at least one of the embodiments of the present invention, a control device capable of providing information desired by an occupant in response to speaking of the occupant during traveling may be provided. According to at least one of the embodiments of the present invention, a control device capable of inferring a related keyword in response to speaking of an occupant during traveling and providing a search result on the basis of the related keyword may be provided. According to at least one of the embodiments of the present invention, a control device capable of updating a related keyword in response to a speaking of occupant and providing a search result on the basis of the related keyword may be provided.

The control method according to the present invention have effects as follows. According to at least one of the embodiments of the present invention, a control method for driving assistance of a vehicle may be provided. According to at least one of the embodiments of the present invention, a control method for enabling conversation with an occupant during traveling may be provided. According to at least one of the embodiments of the present invention, a control method for providing information desired by an occupant in response to speaking of the occupant during traveling may be provided. According to at least one of the embodiments of the present invention, a control method for inferring a related keyword in response to speaking of an occupant during traveling and providing a search result on the basis of the related keyword may be provided. According to at least one of the embodiments of the present invention, a control method for updating a related keyword in response to speaking of occupant and providing a search result on the basis of the related keyword may be provided.

The control device or the control method according to the above-described embodiments may assist a driver to drive the vehicle. The control device or the control method according to the above-described embodiments may assist the vehicle to travel autonomously or semi-autonomously.

The above described features, configurations, effects, and the like are included in at least one of the implementations of the present disclosure, and should not be limited to only one implementation. In addition, the features, configurations, effects, and the like as illustrated in each implementation may be implemented with regard to other implementations as they are combined with one another or modified by those skilled in the art. Thus, content related to these combinations and modifications should be construed as being included in the scope of the accompanying claims.

Further, although the implementations have been mainly described until now, they are just exemplary and do not limit the present disclosure. Thus, those skilled in the art will understand that various modifications and applications which have not been exemplified may be carried out within a range which does not deviate from the essential characteristics of the implementations. For instance, the constituent elements described in detail in the exemplary implementations can be modified to be carried out. Further, the differences related to such modifications and applications shall be construed to be included in the scope of the present disclosure specified in the attached claims.

1. A control method for controlling a vehicle using an agent module generating a dialogue which constructs a dialogue-type response to a received speaking of an occupant, the method comprising:
receiving the speaking of the occupant through a voice input unit;
updating the dialogue as a procedure of providing a search result in response to a search request through the speaking of the occupant is performed multiple times; and
displaying in real time, on a display, a procedure of updating the dialogue,
wherein the updating of the dialogue comprises:
updating keywords, inferred from the speaking of the occupant, on the basis of a subsequently input speaking of the occupant; and
providing the search result on the basis of the updated keywords, and
wherein, in the displaying on the display, the keywords inferred from the speaking of the occupant through the agent module are displayed with different display attributes and thereby visually distinguishable from each other.

2. The control method of claim 1, wherein the updating of the dialogue further comprises:
extracting at least one keyword directly included in a first speaking of the occupant as a first search query;
extracting at least one keyword inferred from the speaking of the occupant as a second search query; and
displaying the first search query, the second search query, and a first search result found on the basis of the first search query.

3. The control method of claim 2, further comprising:
after the first search result is provided, receiving a second speaking of the occupant; and
when it is determined based on the second speaking that it is necessary to modify at least one keyword in the second query into a keyword included in the second speaking, modifying the at least one keyword in the second query into the first search query.

4. The control method of claim 3, further comprising:
when it is determined based on the second speaking that it is necessary to re-infer at least one keyword in the second search query, re-inferring the at least one keyword in the second search query and converting the re-inferred at least one keyword into a third search query; and
displaying, on the display, a second search result found on the basis of the updated first search query.

5. The control method of claim 4, wherein, in the displaying on the display, the first search query, the second search query, and the third search query are displayed with different display attributes and thereby visually distinguishable from each other.

6. The control method of claim 5, wherein, in the displaying on the display, the first search query, the second search query, and the third search query are displayed in different colors.

7. The control method of claim 5, wherein, in the displaying on the display, the first search query, the second search query, and the third search query are displayed by updating display attributes thereof in real time according to the first speaking and the second speaking which are sequentially received.

8. The control method of claim 2, further comprising displaying the dialogue on the display,
wherein a dialogue window for displaying conversation between the occupant and the agent module, and the search result are displayed together.

9. The control method of claim 8, wherein the search result provides a list comprising at least one image or at least one text corresponding to the search result.

10. The control method of claim 8, further comprising:
recognizing the speaking of the occupant and converting the speaking into a first text;
through the agent module, generating a response to the speaking of the occupant or a second text explaining the search result; and
through a voice output unit, outputting at least a part of the second text,
wherein the dialogue window is divided into a first area for selectively displaying the first text and the second text and a second area for displaying the first search query and the second search query, the second area which excludes the first area.

11. The control method of claim 10, wherein the first text displayed in the first area comprises an entire of the speaking of the occupant, and at least a part of the second text is displayed in the first area as a text, an image, or a graphic object.

12. The control method of claim 10, wherein the first area is a circular graphic object.

13. The control method of claim 10,
wherein the first search query and the second search query are represented by bubble-shaped graphic objects,
wherein keywords of a search query are displayed within independent bubbles, and
wherein when the respective keywords are extracted by an identical criteria or similar criterion, at least a part of a bubble of each of the respective keywords is connected to each other.

14. The control method of claim 13, wherein a criteria for extracting the keywords comprises at least one of a route, location information, time, speaking content of the occupant, or a search source.

15. The control method of claim 2, wherein at least one keyword forming the second search query comprises a keyword extracted by the agent module or received from an external server through a wireless communication unit.

16. A control device comprising:
a display;
a voice input unit receiving a speaking of an occupant;
an agent module generating a dialogue with a dialogue-type response to the received speaking of the occupant; and
a controller, wherein the dialogue is constructed of a search request through the speaking of the occupant and a search result provided by the agent module, and the controller displays, on the display, a procedure of updating the dialogue, as a procedure of speaking by the occupant and providing a search result by the agent modules is performed multiple times,
wherein the agent module updates keywords, inferred from the speaking of the occupant, on the basis of a subsequently input speaking of the occupant, and provides a search result on the basis of the updated keywords, and
wherein the controller displays the keywords, inferred from the speaking of the occupant through the agent module, with different display attributes and thereby visually distinguishable from each other.

17. The control device of claim 16,
wherein the agent module extracts at least one keyword directly included in a first speaking of the occupant as a first search query, and extracts at least one keyword inferred from the speaking of the occupant as a second search query, and
wherein the controller displays, on the display, the first search query, the second search query, and a first search result found on the basis of the first search query.

18. The control device of claim 17, wherein the agent module recognizes a second speaking of the occupant after the provision of the first search result, and, when it is determined based on the second speaking that it is necessary to modify at least one keyword in the second search query into a keyword included in the second speaking, the agent module modifies the at least one keyword in the second search query into the first search query.

19. The control device of claim 18,
wherein when it is determined based on the second speaking it is necessary to re-infer at least one keyword in the second search query, the agent module re-infers the at least one keyword in the second search query and extract the re-inferred at least one keyword as a third search query, and
wherein the controller displays, on the display, a second search result found on the basis of the updated first search query.

20. The control device of claim 19, wherein the controller performs a control operation such that the first search query, the second search query, and the first search result found on the basis of the first search query are displayed with different display attributes and thereby visually distinguishable from each other.
